(19) United States
(12) Patent Application Publication
(10) Pub. No.: US 2025/0237359 A1
(43) Pub. Date: Jul. 24, 2025

(54) MODEL -BASED FAULT DETECTION DEVICE AND METHOD FOR LIQUID HYDROGEN REFUELING SYSTEM USING CUMULATIVE SUM METHOD, AND COMPUTER PROGRAM

(71) Applicant: KWANGWOON UNIVERSITY INDUSTRY-ACADEMIC COLLABORATION FOUNDATION, Seoul (KR)

(72) Inventors: Yeonsoo KIM, Seoul (KR); Gyeonggwan JEON, Seoul (KR)

(21) Appl. No.: 19/013,601

(22) Filed: Jan. 8, 2025

(30) Foreign Application Priority Data
Jan. 18, 2024 (KR) 10-2024-0007964

(51) Int. Cl. F17C 13/12

(52) U.S. Cl. CPC F17C 13/12; F17C 2221/012; F17C 2223/0153; F17C 2227/0142; F17C 2250/0694; F17C 2260/04; F17C 2265/06; F17C 2270/0171

(57) ABSTRACT

A model-based fault detection device for a liquid hydrogen refueling system using a cumulative sum method includes a memory that stores instructions, and a processor configured to, by executing the instructions, obtain process variables inside a liquid hydrogen storage system based on a simulation model for the liquid hydrogen storage system, obtain normal scenario data and fault scenario data of the process variables by using a steady-state model and a dynamic state model for the liquid hydrogen storage system, calculate an upper end cumulative sum index Cᵢ⁺ and a lower end cumulative sum index Cᵢ⁻ by applying a cumulative sum (CUSUM) control method to deviation data corresponding to a difference between the normal scenario data and the fault scenario data, and detect whether the liquid hydrogen storage system is faulty by comparing the upper end cumulative sum index Cᵢ⁺ and the lower end cumulative sum index _{C}⁻ i with a threshold.

### CROSS-REFERENCE TO RELATED APPLICATION

This application claims priority to Korean Patent Application No. 10-2024-0007964filed on Jan. 18, 2024 and all the benefits accruing therefrom under 35 U.S.C. § 119, the contents of which are incorporated by reference in their entirety.

This work was supported by National Research and Development Projects Supporting This Invention, Ministry of Trade, Industry and Energy (Project Identification Number: 1415182102, Project Number: 20227310100010). The Project Management Specialist Agency is the Korea Institute of Energy Technology Evaluation and Planning, and Research Project Name is Development of Liquefied Hydrogen Charging Core Components and Facility Safety Technology and Safety Assessment/Verification and Safety Standard Development Linked with Liquefied Hydrogen Charging Station Construction. The Project Executing Agency is Korea Gas Technology Corporation, and the Research Period is 2022 Apr. 1-2025 Mar. 31.

### BACKGROUND

The present disclosure relates to an algorithm for detecting an occurrence of a fault condition based on a model using a cumulative sum (CUSUM) method in a liquid hydrogen refueling system.

Research on liquid hydrogen refueling systems is still in its early stage, and preemptive research such as modeling and simulation is being conducted accordingly. Liquid hydrogen has the disadvantage of requiring large-scale facility investment and consuming additional energy to liquefy gaseous hydrogen, but, according to the results of economic evaluation of the entire cycle from production, storage, transfer, and sale of hydrogen at hydrogen refueling stations using an economic analysis model for hydrogen refueling stations (HDSAM; Hydrogen Delivery Scenario Analysis Model) provided by the U.S. Department of Energy (DOE), it was confirmed that a hydrogen liquefaction method is economical. It can be said that, at liquid hydrogen refueling stations, the key is to minimize hydrogen loss and supply hydrogen to vehicles without causing safety accidents.

In the case of liquid hydrogen, it is difficult to precisely analyze the behavior according to minute changes in temperature and pressure due to the characteristics of cryogenic fluids, and in particular, the occurrence of boil-off gas (BOG) is unavoidable. The generation of the BOG while operating the liquid hydrogen refueling station not only causes economic loss, but also has the risk of explosion, which causes various safety accidents that can occur in the process. Therefore, in order to ensure economic feasibility and safety through simulation, it may be necessary to perform modeling of the process in advance before constructing and operating an actual liquid hydrogen refueling station.

Examples of related art include Korean Patent Application Publication No. 10-2012-0045319.

### SUMMARY

The present disclosure provides a model-based fault detection device and method for a liquid hydrogen refueling system using a cumulative sum method that ensure economic feasibility and safety through simulation by performing modeling of the process in advance before constructing and operating an actual liquid hydrogen refueling station in order to prevent various safety accidents that may occur in a liquid hydrogen refueling system, and a computer program that is recorded on a non-transitory computer-readable storage medium.

The technical purpose of the present disclosure is not limited to the technical problems mentioned above, and other technical problems that are not mentioned can be clearly understood by those skilled in the art from the description below.

In accordance with an exemplary embodiment of the present invention, a model-based fault detection algorithm for a liquid hydrogen refueling system using a cumulative sum method includes a memory that stores instructions, and a processor configured to, by executing the instructions, obtain process variables inside a liquid hydrogen storage system based on a simulation model for the liquid hydrogen storage system, obtain normal scenario data and fault scenario data of the process variables by using a steady-state model and a dynamic state model for the liquid hydrogen storage system, calculate an upper end cumulative sum index Cᵢ⁺ and a lower end cumulative sum index Cᵢ⁻ by applying a cumulative sum (CUSUM) control method to deviation data corresponding to a difference between the normal scenario data and the fault scenario data, and detect whether the liquid hydrogen storage system is faulty by comparing the upper end cumulative sum index Cᵢ⁺ and the lower end cumulative sum index Cᵢ⁻ with a threshold.

According to some embodiments of the present invention, the simulation model for the liquid hydrogen storage system may be configured to model mass balance and energy balance for a process of transferring liquid hydrogen from a trailer tank to a storage tank and a process of transferring the liquid hydrogen from the storage tank to a cryo-pump.

According to some embodiments of the present invention, the simulation model for the liquid hydrogen storage system may be configured to further model mass balance and energy balance for a boil-off gas (BOG) vent process for venting boil-off gas generated in the storage tank and a vapor return process for returning hydrogen vapor to the storage tank to maintain hydrogen vapor pressure in the storage tank.

According to some embodiments of the present invention, the simulation model for the liquid hydrogen storage system may be configured to model the storage tank based on a horizontal storage tank of which a side surface of a cylinder faces the ground and upper and lower surfaces of the cylinder are perpendicular to the ground based on a top fill method in which liquid hydrogen is filled from the trailer tank to an upper end part of the storage tank.

According to some embodiments of the present invention, the normal scenario data according to the steady-state model represents a scenario in which the liquid hydrogen supplied from the trailer tank is flown out to the cryo-pump after being filled up to the maximum capacity in the storage tank, and the dynamic state model may be configured to model a first fault scenario that occurs in a process in which the liquid hydrogen is filled from the trailer tank to the storage tank, a second fault scenario that occurs in a process in which the liquid hydrogen is delivered from the storage tank to the cryo-pump, and a third fault scenario that occurs in a process in which the liquid hydrogen delivered through the cryo-pump is vaporized in a heat exchange vaporizer.

According to some embodiments of the present invention, the first fault scenario may include a scenario in which a vent threshold of a BOG vent process for venting boil-off gas (BOG) generated within the storage tank decreases, a scenario in which an external fire occurs, and a scenario in which a top fill method is changed to a bottom fill method, the second fault scenario may include a scenario in which a return line valve is closed in a vapor return process for returning hydrogen vapor to the storage tank, a scenario in which a flow rate of the liquid hydrogen delivered from the storage tank to the cryo-pump decreases due to impurity blockage, a scenario in which a flow rate of the liquid hydrogen delivered from the storage tank to the cryo-pump increases, and a scenario in which a residual amount of the liquid hydrogen within the storage tank is insufficient, and the third fault scenario may include a scenario in which pressure at which the liquid hydrogen enters the heat exchange vaporizer from the cryo-pump increases.

According to some embodiments of the present invention, the process variables used to obtain the normal scenario data and the fault scenario data may include hydrogen vapor pressure, hydrogen vapor temperature, and liquid hydrogen temperature measured in a storage tank of the liquid hydrogen storage system, and the processor may be configured to apply a cumulative sum (CUSUM) control method to the deviation data regarding the hydrogen vapor pressure, the hydrogen vapor temperature, and the liquid hydrogen temperature to calculate an upper end cumulative sum index Cᵢ⁺ and a lower end cumulative sum index Cᵢ⁻.

In accordance with another exemplary embodiment of the present invention, a model-based fault detection method for a liquid hydrogen refueling system using a cumulative sum method, which is performed by a processor executing instructions stored in a memory, includes obtaining process variables inside a liquid hydrogen storage system based on a simulation model for the liquid hydrogen storage system, obtaining normal scenario data and fault scenario data of the process variables by using a steady-state model and a dynamic state model for the liquid hydrogen storage system, calculating an upper end cumulative sum index Cᵢ⁺ and a lower end cumulative sum index Cᵢ⁻ by applying a cumulative sum (CUSUM) control method to deviation data corresponding to a difference between the normal scenario data and the fault scenario data, and detecting whether the liquid hydrogen storage system is faulty by comparing the upper end cumulative sum index Cᵢ⁺ and the lower end cumulative sum index Cᵢ⁻ with a threshold.

In accordance with still another exemplary embodiment of the present invention, a computer program is recorded on a non-transitory computer-readable storage medium, in which instructions of the computer program, when executed by at least one processor, cause at least one processor to perform a model-based fault detection method for a liquid hydrogen refueling system using a cumulative sum method.

### BRIEF DESCRIPTION OF THE DRAWINGS

Exemplary embodiments can be understood in more detail from the following description taken in conjunction with the accompanying drawings, in which:

FIG. 1 illustrates a structure and operation method of a liquid hydrogen refueling system according to some embodiments;

FIG. 2 illustrates a flow and structure of a liquid hydrogen refueling system according to some embodiments;

FIG. 3 illustrates a process of calculating a cumulative sum (CUSUM) control chart according to some embodiments;

FIG. 4 illustrates an initial modeling structure of a liquid hydrogen refueling system according to some embodiments;

FIG. 5 illustrates process variables of a liquid hydrogen storage tank in an initial modeling structure according to some embodiments;

FIG. 6 illustrates modeling differences between a horizontal tank and a vertical tank according to some embodiments;

FIG. 7 illustrates a specific heat exchange calculation formula for a horizontal tank according to some embodiments;

FIG. 8 illustrates a structure that further includes a transfer line from a storage tank to a cryo-pump according to some embodiments;

FIG. 9 illustrates a model for heat exchange between a wall inside a storage tank and an outside thereof according to some embodiments;

FIG. 10 illustrates simulation results of a horizontal storage tank expanded to further include a cryo-pump according to some embodiments;

FIG. 11 illustrates changes due to the addition of a vapor return line for maintaining pressure difference and the application of a top fill method according to some embodiments;

FIG. 12 illustrates differences between a top fill method and a bottom fill method according to some embodiments;

FIG. 13 illustrates simulation changes due to the addition of a vapor return line for maintaining pressure difference according to some embodiments;

FIG. 14 illustrates the results of application of a top fill method compared to a bottom fill method according to some embodiments;

FIG. 15 illustrates a steady-state simulation model for a liquid hydrogen refueling system according to some embodiments;

FIG. 16 illustrates a dynamic-state simulation model for a liquid hydrogen refueling system according to some embodiments;

FIG. 17 illustrates fault condition scenarios for a liquid hydrogen refueling system according to some embodiments;

FIG. 18 illustrates an outline of a fault detection algorithm for a liquid hydrogen refueling system according to some embodiments;

FIG. 19 illustrates process variables measured in a simulation model according to some embodiments;

FIGS. 20 to 29 illustrate a process of detecting a fault condition in fault condition scenarios according to some embodiments;

FIG. 30 illustrates a model-based fault detection device for a liquid hydrogen refueling system using a cumulative sum method according to some embodiments; and

FIG. 31 illustrates a model-based fault detection method for a liquid hydrogen refueling system using a cumulative sum method according to some embodiments.

### DETAILED DESCRIPTION OF EMBODIMENTS

Hereinafter, embodiments of the present invention will be described in detail with reference to the accompanying drawings. The following description is intended only to specify embodiments, and is not intended to limit or restrict the scope of rights according to the present invention. Matters that can be easily inferred from the detailed description and examples of the invention by a person having ordinary knowledge in the technical field related to the present invention should be interpreted as as falling within the scope of rights according to the present invention. Detailed descriptions of matters widely known to a person having ordinary knowledge in the technical field related to the present invention are omitted.

Terms used in the present invention are described as general terms widely used in the technical field related to the present invention, but the meanings of the terms used in the present invention may vary depending on the intention of a technician engaged in the relevant field, the emergence of new technologies, examination standards, or precedents. Some terms may be arbitrarily selected by the applicant, and in this case, the meanings of terms arbitrarily selected will be described in detail. The terms used in the present invention should be interpreted not only as dictionary meanings, but also as meanings reflecting the overall context of the specification.

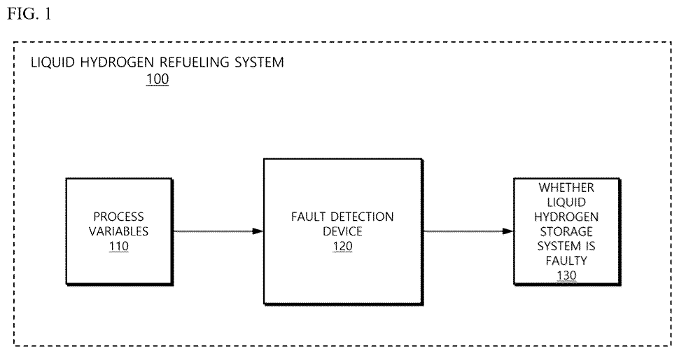

FIG. 1 illustrates a structure and operation method of a liquid hydrogen refueling system according to some embodiments.

Referring to FIG. 1, a fault detection device 120 may diagnose whether a liquid hydrogen refueling system 100 is faulty based on process variables 110 of the liquid hydrogen refueling system 100.

The present invention proposes an algorithm that can detect and monitor various fault (abnormal) situations that may occur in the liquid hydrogen refueling system 100 using a cumulative sum (CUSUM) method. In order to check the detailed physical behavior of liquid hydrogen, which is a cryogenic fluid of −253° C. and BOG occurrence, a precise tank model for a liquid hydrogen storage tank was constructed using MATLAB code. Using the model, normal operation scenarios and various fault scenarios of the system were generated, and differences between result values of the two scenarios were converted into data.

Using the CUSUM method in which a cumulative sum of deviations of plotted samples from the target value is displayed, the degree and point in time when a data value of the corresponding data deviates upward or downward from the mean is detected. When a fault situation occurs, a negative or positive data value occurs as much as it deviates from ae normal scenario, and in this case, since a (normal-fault) value is converted into data, if a fault value is measured higher than a normal value, the data value has a negative value, and if the fault value is measured lower than the normal value, the data value has a positive value. Finally, the point in time when it deviates from a threshold designated in this model is detected and displayed.

The technology of the present invention is a technology for fault detection monitoring to ensure initial model configuration and stability for a liquid hydrogen refueling system in accordance with the government's energy transition policy, designation of the hydrogen economy as a future growth engine, hydrogen car distribution and and promoting the expansion of hydrogen refueling station infrastructure as tasks for early entry. This technology proposes a technology that can detect the time in point through simulation of various fault situations that may occur in the process to enable early detection and response to safety accidents that may occur in an actual liquid hydrogen refueling station system.

The present invention contributes greatly to the early detection and dealt with fault situations and safety accidents that may occur in the system by preemptively conducting modeling of the liquid hydrogen refueling system and presenting simulation results through this modeling. In the case of liquid hydrogen, it is difficult to precisely analyze the behavior according to minute changes in temperature and pressure due to the characteristics of cryogenic fluid, and in particular, the occurrence of BOG is unavoidable. The occurrence of BOG while operating a liquid hydrogen refueling station not only causes economic losses, but also has the risk of explosion, which causes various safety accidents that may occur in the process.

Therefore, if the process is modeled in advance before constructing and operating an actual liquid hydrogen refueling station, the economic feasibility and safety can be guaranteed through the simulation. In the present invention, the simulation was conducted by modeling a liquid hydrogen refueling system and applying a fault detection algorithm thereto using the CUSUM method, and it was possible to quickly detect subtle changes in the process due to the occurrence of a fault situation.

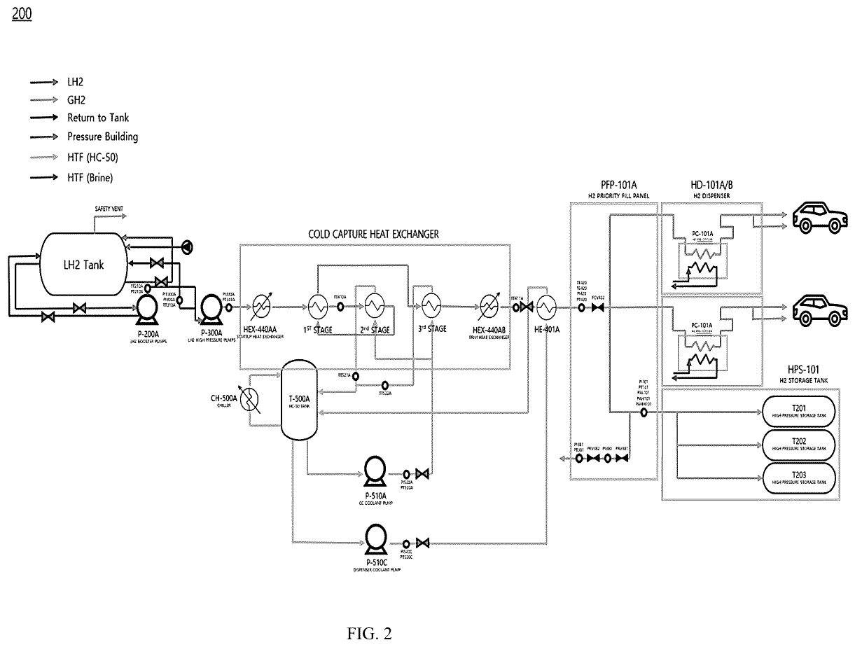

FIG. 2 illustrates a flow and structure of a liquid hydrogen refueling system according to some embodiments.

Referring to FIG. 2, the flow and structure of a liquid hydrogen refueling system 200 may be illustrated. Devices that makes up the liquid hydrogen refueling system 200 largely include a liquid hydrogen storage tank, a two-stage cryo-pump, a heat exchanger (vaporizer), a gaseous hydrogen storage tank (buffer tank), and a vehicle refueling dispenser.

### Flow and Structure of Liquid Hydrogen Refueling System

Liquid hydrogen produced through a hydrogen liquefaction process is transported in the form of a tank lorry and stored in the liquid hydrogen storage tank. In this case, since liquid hydrogen is a cryogenic fluid of −253° C., heat inflow from the outside is inevitable no matter how well the storage tank is insulated. Accordingly, a boil-off phenomenon, in which liquid hydrogen is vaporized by heat inflow from the outside, occurs in the storage tank. In the storage tank, there is a BOG vent flow to discharge boil-off gas (hereinafter referred to as BOG) generated by the boil-off phenomenon, a flow that sends the liquid hydrogen to the cryo-pump, and a vapor return (pressure building) flow to maintain the pressure in the storage tank.

As the BOG is continuously generated, the pressure inside the storage tank increases and there is a risk of explosion. Therefore, the BOG is ventilated to ensure stability and to regulate the pressure inside the storage tank. The liquid hydrogen in the storage tank is pressurized stepwise from approximately 3 bar to 8.3 bar and 900 bar through the cryo-pump. After that, the liquid hydrogen is heated through a heat exchanger (vaporizer) and moved to a gaseous hydrogen storage tank, and finally fueled into a hydrogen vehicle at a pressure of approximately 700 bar.

### Fault Detection Algorithm-Process Monitoring

Process monitoring is a process of checking whether normal conditions are maintained without any special problems during process operation. A general goal of monitoring is first to routinely check whether process variables exist well within a designated range, and then to detect and diagnose the cause when the process is abnormally operating when a fault occurs in the process. Therefore, process monitoring is a broad concept that includes the content of fault detection. In addition, the goal of process monitoring is to detect and prevent problems in the process early before they occur due to the occurrence of a fault situation.

Causes of fault situations and abnormal operations may include a case where there is a problem with a device or instrument or when an abnormal disturbance occurs, and there are many other causes. The process monitoring or fault detection method may be broadly divided into three as follows. First, there is a method of constructing a direct mathematical model and comparing actual results with this model. This method is the most direct, but has the disadvantage of having to construct a mathematical model that includes all possible errors and causes of a fault. Next, there is a method of hiring experts or using knowledge-based models such as neural networks. This method has an advantage of not requiring a mathematical model, but has a disadvantage that in the case of expert systems, the expert's empirical knowledge is likely to be subjective, and in the case of neural networks, a lot of data is needed to train, but it is difficult to obtain such data from actual processes. Lastly, in the case of statistical process control (SPC), it is a method that uses real-time measurement data, and this method has the advantage of being able to use the data directly and intuitively interpret it using a control chart. Types of the SPC include Shewhart control chart, cumulative sum (CUSUM) control chart, exponentially weighted moving average (EWMA) control chart, etc.

In the present invention, a fault detection logic is designed to utilize both calculated values of the developed models and actual data. In the case of this liquid hydrogen refueling station, since there is no previously secured operation data, a model is used to present the behavior of temperature, pressure, and flow rate in normal situations. Based on the deviation the behavior of temperature, pressure, and flow rate and actual data, whether it is normal or faulty is detected. When a simple logic that detects whether it is normal or faulty by setting a threshold for the deviation itself is utilized, it can become a fault detection logic that is sensitive to momentary noise. Alternatively, when setting a large threshold to avoid being sensitive to momentary noise, it has the disadvantage of not being able to detect a fault quickly. In the present invention, a fault detection algorithm was constructed by utilizing cumulative information of deviations using the CUSUM control chart method that can solve these problems.

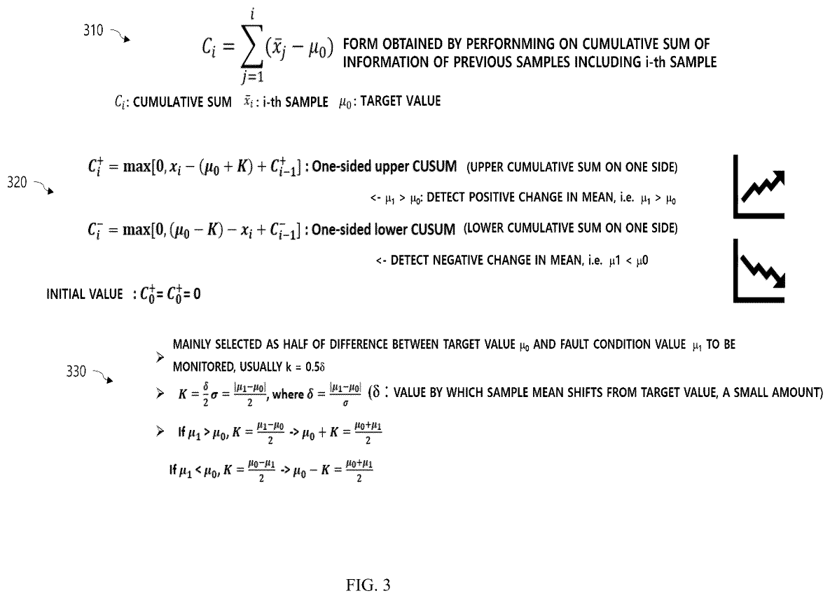

FIG. 3 illustrates a process of calculating a CUSUM control chart according to some embodiments.

Referring to FIG. 3, a formula 310 for calculating a CUSUM control chart, a formula 320 for calculating an upper end cumulative sum and a lower end cumulative sum of the CUSUM control chart, and a description 330 of a reference value K of the CUSUM control chart are illustrated.

The CUSUM control chart can be said to be a time-weighted control chart that displays the cumulative sum of deviations of plotted samples from a target value. The CUSUM control chart is useful for detecting that the mean of the process gradually changes from an existing value to another value, and when the process mean actually moves, an upward or downward tendency appears depending on the change in the value thereof. The CUSUM control chart is more efficient than other control charts in detecting very small process changes because it utilizes information obtained from multiple samples. The formula 310 is a cumulative sum formula used in CUSUM, and is in the form of accumulating and adding the difference between the sample and the mean.

In the CUSUM, a positive or negative change in the mean is detected, and is calculated as in the formula 320. In this case, K is a reference value (allowance value, slack value), and its characteristics are the same as in the description 330. As the decision interval or control limit H, 4σ or 5σ is generally used, where σ means the standard deviation. If Cᵢ⁺>H or Cᵢ⁻>H, it can be known that it is a fault signal that a positive or negative change in the mean has occurred.

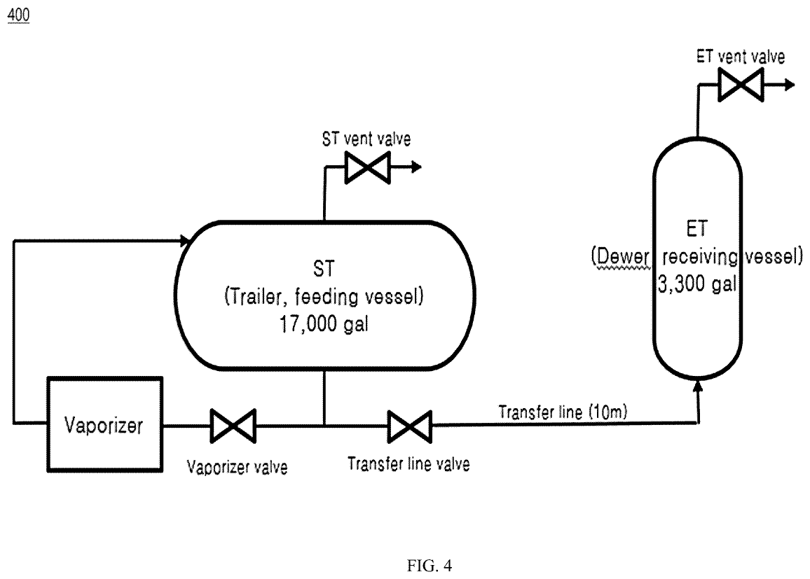

FIG. 4 illustrates an initial modeling structure of a liquid hydrogen refueling system according to some embodiments.

Referring to FIG. 4, an initial modeling structure 400 of a liquid hydrogen refueling system is illustrated. In the initial stage of modeling, complex physical phenomena such as competition between condensation and evaporation, conduction, and convection heat transfer were implemented, and an actual gas state equation and transfer characteristics were considered by linking to a database called REFPROP.

Initially, a system that transfers liquid hydrogen produced in a hydrogen liquefaction process from a trailer tank ST to a storage tank ET and store it in the storage tank was considered. The driving force for transferring liquid hydrogen is a pressure difference between the two tanks, and the liquid hydrogen is transferred by maintaining the pressure difference between the two tanks through a vaporizer in the trailer tank. The liquid hydrogen is transferred until 90% of the storage tank is filled, and maintained at that level once the storage tank is filled up to 90% thereof.

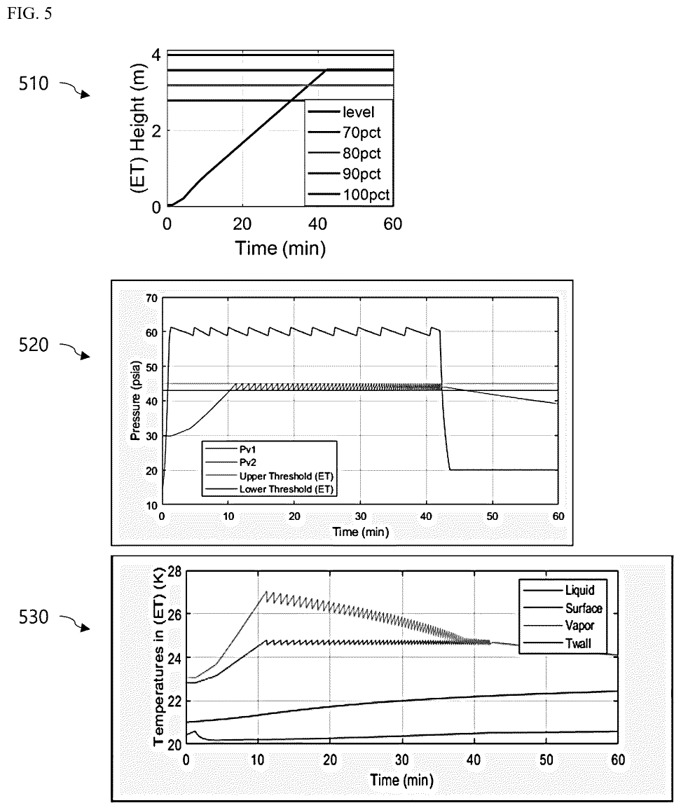

FIG. 5 illustrates process variables of a liquid hydrogen storage tank in an initial modeling structure according to some embodiments.

Referring to FIG. 5, a graph 510 showing a change in the liquid hydrogen level in the storage tank, a graph 520 showing a change in the vapor pressure Pv2 in the tank, and a graph 530 showing a change in the temperature in the storage tank are illustrated.

Regarding the graph 510, a specific pressure reference range of 43 psia (lower, approximately 2.96 bar) to 45 psia (upper, approximately 3.1 bar) was set for the storage tank, and a control logic to vent BOG to maintain the tank pressure within this range was also constructed therein. Regarding the graph 520, temperature changes of the liquid, vapor, surface between the liquid and the vapor, and a tank wall in the storage tank during the time when the liquid hydrogen is transferred are calculated. Through the results, it was confirmed that generally the temperature of liquid hydrogen is around 20 K to 21 K of temperature in Kelvin.

Regarding the graph 530, in consideration of the fact that the temperature of the liquid, vapor, and surface in the storage tank can be calculated in this way, a precise tank model was constructed using MATLAB. The focus of this code is the storage tank, and by modifying and expanding the code that was initially developed, we attempted to add the switching from a vertical tank to a horizontal tank and a flow flowing out of the storage tank to the pump. The reason for changing to the horizontal tank is that the shape of the tank used in the actual system is horizontal.

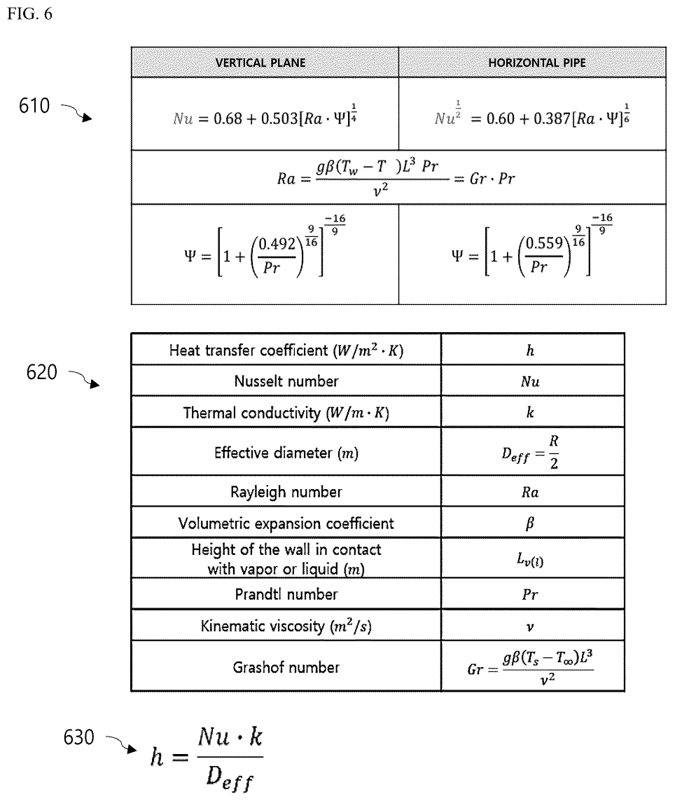

FIG. 6 illustrates modeling differences between a horizontal tank and a vertical tank according to some embodiments.

Referring to FIG. 6, a table 610, a table 620, and a formula 630 for comparing a heat transfer formula of a horizontal pipe with that of a vertical shaped pipe are illustrated.

Regarding the modeling of a horizontal storage tank, as mentioned above, the storage tank actually used is a horizontal tank, and thus the vertical tank used in the initial code should be modified to a horizontal tank. The reason is that there is a difference in the heat exchange calculation formula to be applied depending on the vertical or horizontal shape. If a heat transfer coefficient h is calculated using the Nusselt number, which is a dimensionless number related to heat transfer, it is as shown in the formula 630.

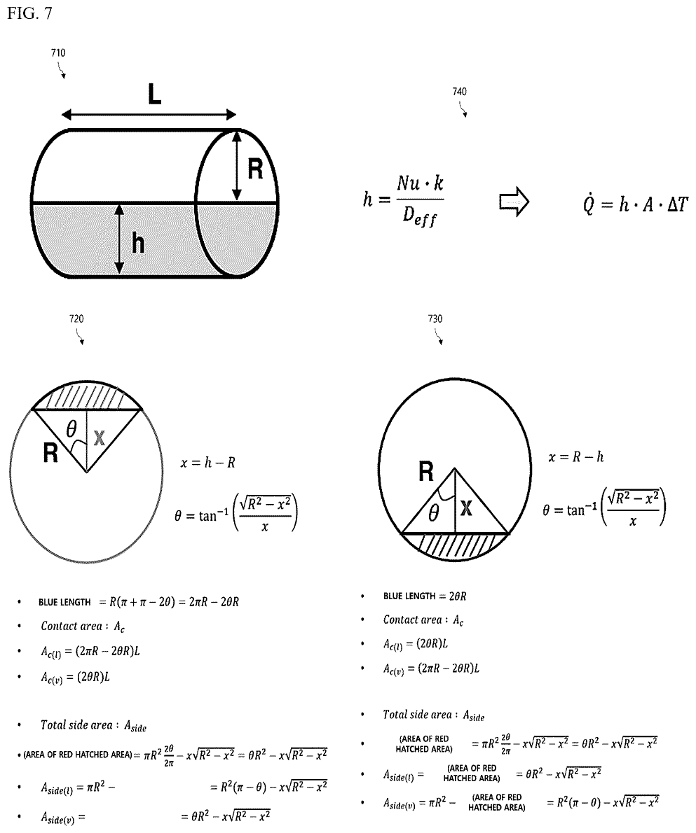

FIG. 7 illustrates a specific heat exchange calculation formula for a horizontal tank according to some embodiments.

Referring to FIG. 7, a structure 710 of a horizontal tank, heat transfer area calculation methods 720 and 730, and a formula 740 for a heat exchange amount in the case of the horizontal structure are illustrated.

As in the structure 710 of the horizontal tank, a heat transfer area was calculated by assuming a side surface of the horizontal tank to be a flat plate, and the calculation process is the same as the heat transfer area calculation methods 720 and 730. The heat transfer area calculation method 720 is a calculation method when a water level h is greater than a tank radius R (h>R), and the heat transfer area calculation method 730 is a calculation method when the water level h is less than the tank radius R (h<R). If the heat exchange amount when the storage tank is changed to a horizontal tank is calculated by multiplying the calculated heat transfer coefficient h by the heat exchange area and the temperature difference, the result is as shown in formula 740.

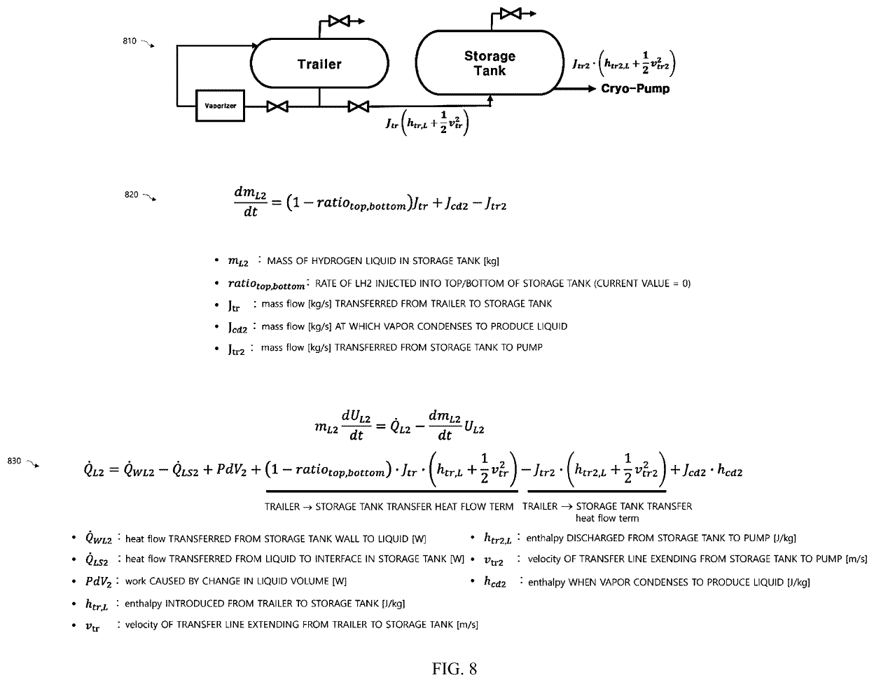

FIG. 8 illustrates a structure that further includes a transfer line extending from a storage tank to a cryo-pump according to some embodiments.

Referring to FIG. 8, a structure 810 that further includes a transfer line extending from the storage tank to the cryo-pump, and a mass balance formula 820 and an energy balance formula 830 that are changed accordingly are illustrated.

Regarding the addition of the transfer line extending from the storage tank to the cryo-pump, since a flow flowing out to the pump was not reflected in the initial code, the system was expanded as in structure 810 by adding a flow of liquid hydrogen in the storage tank that flows out to the pump in consideration of mass balance and energy balance.

In the case of the mass balance, a Jₜᵣ₂ term was added, and the simulation was performed by fixing a flow rate flowing out to the pump to approximately 120 kg/hr (0.0333 kg/s) based on a design value of an actual system. This is expressed as the mass balance formula 820. Likewise, in the case of the energy balance, the energy that escapes when liquid hydrogen flows out along with enthalpy and velocity was also considered. This is expressed as the energy balance formula 830.

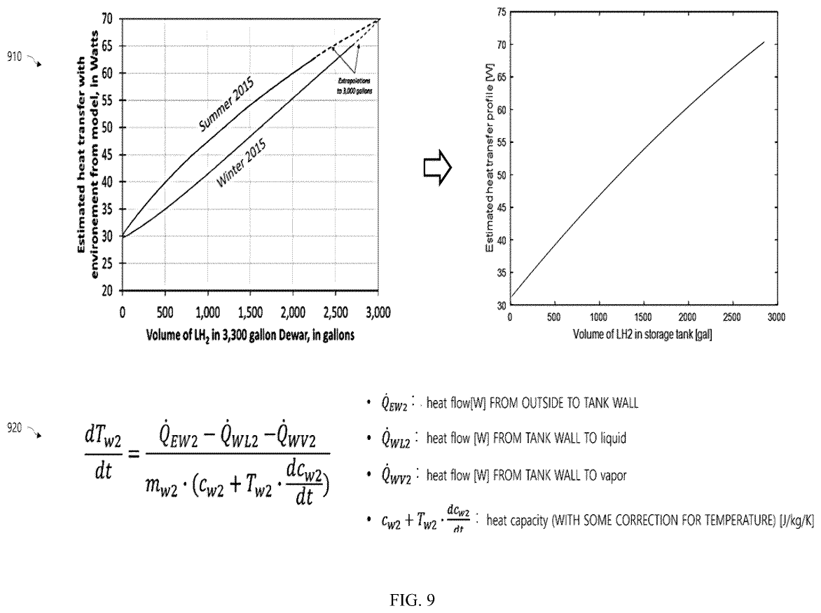

FIG. 9 illustrates a model for heat exchange between a wall inside the storage tank and the outside thereof according to some embodiments.

Referring to FIG. 9, a graph 910 and formula 920 for describing a model for heat exchange between the wall inside the storage tank and the outside thereof are illustrated.

Most of the heat exchange that occurs inside the tank is calculated by the heat exchange formula, but the heat exchange mount between the wall of the storage tank and the outside thereof needs to be correlated through data. Since the formula 920 and the graph 910 related thereto that are correlated with the initial code are present, this formula was used first, which may be updated by reflecting experimental data of an actual storage tank that is secured later.

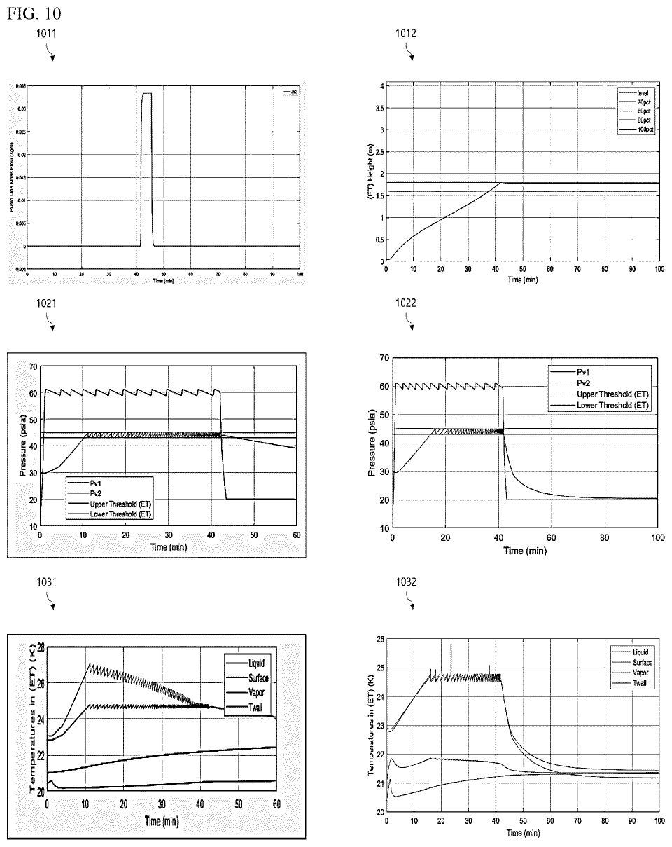

FIG. 10 illustrates simulation results of a horizontal storage tank expanded to further include a cryo-pump according to some embodiments

Referring to FIG. 10, graphs 1011, 1012, 1021, 1022, 1031, and 1032 showing simulation results of a horizontal storage tank expanded to include a cryo-pump are illustrated.

The graph 1011 may represent the flow rate of liquid hydrogen flown out to the pump, and the graph 1012 may represent the height of the storage tank. It was confirmed, through the graphs 1011 and 1012, that the liquid was discharged at a flow rate of approximately 0.0333 kg/s (120 kg/hr) for about 5 minutes, and since the height of the liquid hydrogen filled in the storage tank appears to have been slightly lower than approximately 90% of the existing tank height, it can be seen that some of the liquid is flown out to the pump.

The graph 1021 may represent a pressure behavior inside the tank according to results of the initial code and the graph 1022 may represent the pressure behavior inside the tank according to results of a modified code. It can be seen that the existing code shows a tendency for the vapor pressure to decrease slowly because the storage tank is left alone after the liquid hydrogen in the storage tank is filled to approximately 90% of the height of the storage tank, but in the case of the modified code, the behavior of liquid hydrogen being flown out to the pump after the storage tank is filled up to 90% is added, and thus the vapor pressure inside the tank decreases rapidly.

The graph 1031 represents the temperature behavior inside the tank according to the results of the initial code, and the graph 1032 represents the temperature behavior inside the tank according to the results of the the modified code. It was confirmed that a shape of the temperature behavior inside the tank changed due to the heat transfer characteristics that change as the shape of the storage tank was modified from vertical to horizontal. As with the pressure, it can be seen that the behavior of liquid hydrogen being flown out to the pump is added and thus the temperature inside the tank decreases rapidly.

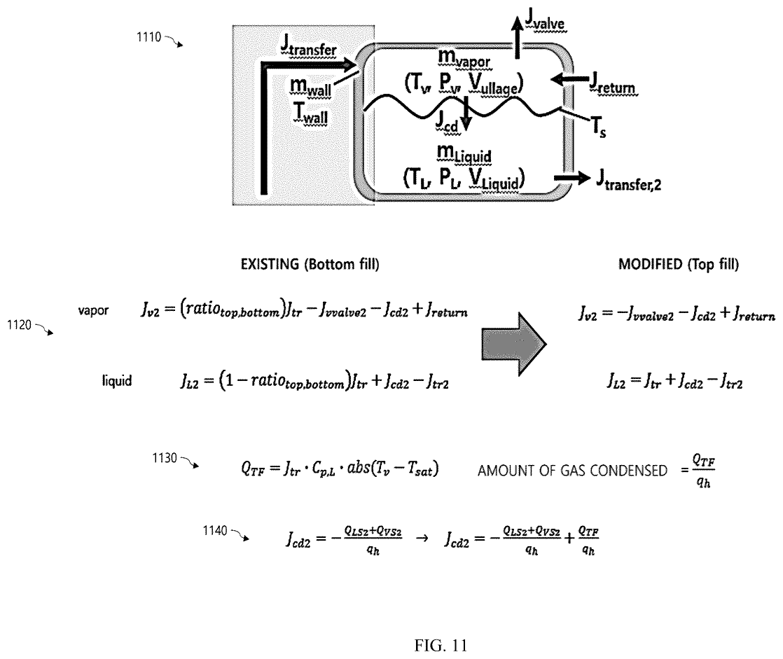

FIG. 11 illustrates changes due to the addition of a vapor return line for maintaining pressure difference and the application of a top fill method according to some embodiments.

Referring to FIG. 11, a structure 1110 according to the addition of a vapor return line for maintaining a pressure difference and the application of a top fill method, and formulas 1120, 1130, and 1140 for describing changes according to the application of the top fill method are illustrated.

Regarding the structure 1110 in which the vapor return line is added and the top fill is applied, the driving force for transferring liquid hydrogen from the storage tank to the pump is a pressure difference between the storage tank and the pump. That is, if the pressure in the storage tank becomes too low, the liquid hydrogen cannot be transferred to the pump, and thus a vapor return line is added as a means for vaporizing some of the liquid hydrogen to increase the tank pressure. In addition, in the case of the existing tank model, it was simulated in the form of bottom fill, in which the liquid hydrogen is filled into the lower end part of the storage tank when the liquid hydrogen is transferred from the trailer to the storage tank. However, in the case of an actual tank, it was confirmed that the tank was a top fill type in which all the liquid hydrogen was filled into the upper part of the storage tank, and the model was modified accordingly.

Regarding the modification of the mass balance and energy balance formulas, in the case of the vapor return, the modification is made in the form of simply adding the balance formula on the vapor side, and in the case of the top fill, ratio_top, bottom=1, but since the hydrogen entering the transfer line is in liquid form, the mass balance formulas for the vapor and liquid were modified accordingly as in the formula 1120.

The amount of heat Q_TF absorbed by the liquid hydrogen, which is injected through the top fill method, from the surrounding vapor and the amount of gas condensed are as shown in the formula 1130. Since the liquid hydrogen entering the transfer line absorbs heat and condenses, a condensation flow rate formula is changed as shown in the formula equation 1140.

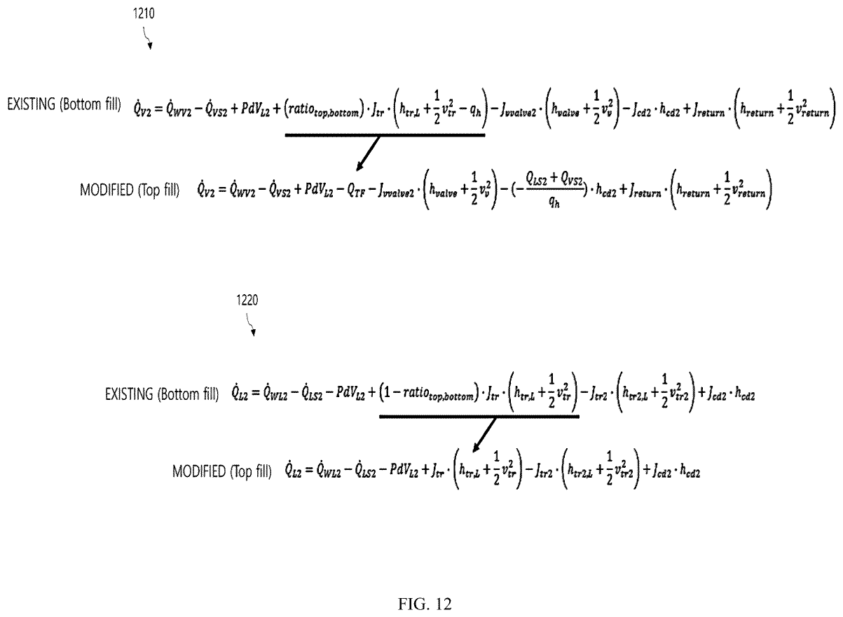

FIG. 12 illustrates differences between a top fill method and a bottom fill method according to some embodiments.

Referring to FIG. 12, a vapor energy balance formula 1210 and a liquid energy balance formula 1220 are illustrated in the top fill method that is modified compared to the bottom fill method.

As in the vapor energy balance formula 1210, the final vapor energy balance formula obtained by applying all the changes in FIG. 11 may be calculated. For the liquid, it is also modified as in the liquid energy balance formula 1220, so that the effect of the liquid hydrogen filled to the upper end part of the storage tank cooling and condensing the surrounding vapor is reflected.

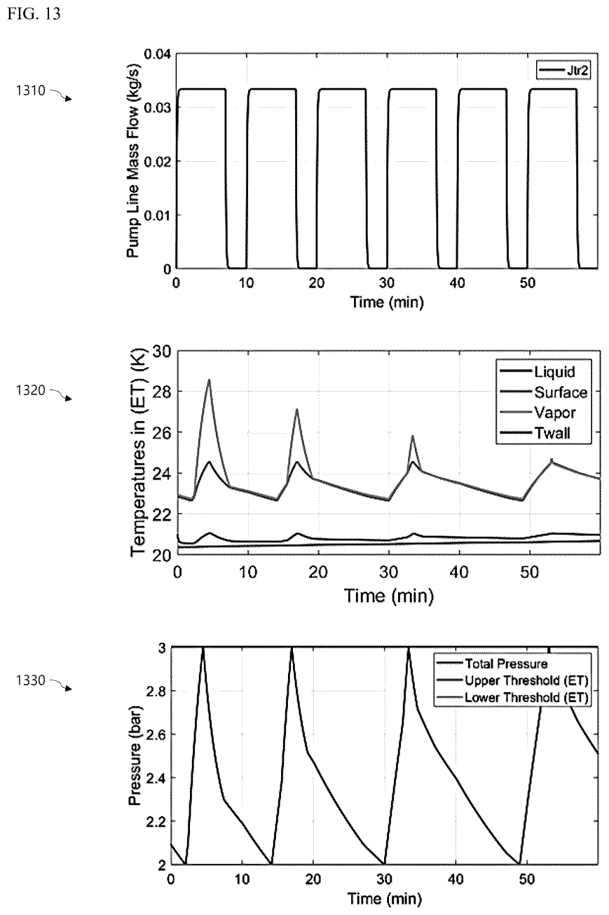

FIG. 13 illustrates simulation changes due to the addition of a vapor return line for maintaining pressure difference according to some embodiments.

Referring to FIG. 13, a flow rate change graph 1310, a temperature change graph 1320, and a pressure change graph 1330 regarding simulation changes due to the addition of a vapor return line for maintaining a pressure difference are illustrated.

Regarding the results of applying the vapor return line, a vehicle filling scenario through a pump after filling a storage tank was simulated to check the effect of the added vapor return line. For simplicity of simulation, the scenario was assumed to be a situation where the vehicle was being filled with liquid hydrogen flowing out through a pump, and the simulation was conducted for approximately 60 minutes with a cycle of approximately 7 minutes of filling and approximately 3 minutes of rest in a state with the storage tank being fully filled (90%).

The pump discharge flow rate is fixed at approximately 0.03333 kg/s (120 kg/h), and when the pressure difference between the storage tank pressure and the pressure for discharging the flow rate of approximately 0.03333 kg/s is between approximately 2 and approximately 3 bar, the pump is turned on and the vehicle is filled with liquid hydrogen. In this case, when the liquid hydrogen is flown out to the pump, the pressure in the storage tank continuously decreases, and when the pressure in the storage tank falls below approximately 2 bar, the vapor return effect occurs, which raise the pressure in the storage tank back to an appropriate range. In the case of the vapor return, the modification is made in the form of simply adding the balance formula on the vapor side, and in the case of the top fill, ratio_top, bottom=1, but since the hydrogen entering the transfer line is in liquid form, the mass balance formulas for the vapor and liquid were modified.

The flow rate change graph 1310 is a graph showing the flow rate change during the vehicle filling simulation, and showing the flow rate of the liquid hydrogen flowing out to the pump line. It is shown that the pump is turned on for approximately 7 minutes and turned off for approximately 3 minutes. The temperature and pressure in the storage tank according to the turn-on and off of the pump are shown in the temperature change graph 1320 and the pressure change graph 1330, and when the pressure in the storage tank decreases less than or equal to approximately 2 bar, the vapor is returned and the pressure rises again. The reason why the temperature of the vapor rises instantaneously at this time is because the temperature of the returned vapor is higher than the temperature of the storage tank, and the temperature of the recovered vapor at the time of vapor recovery is approximately 86 K.

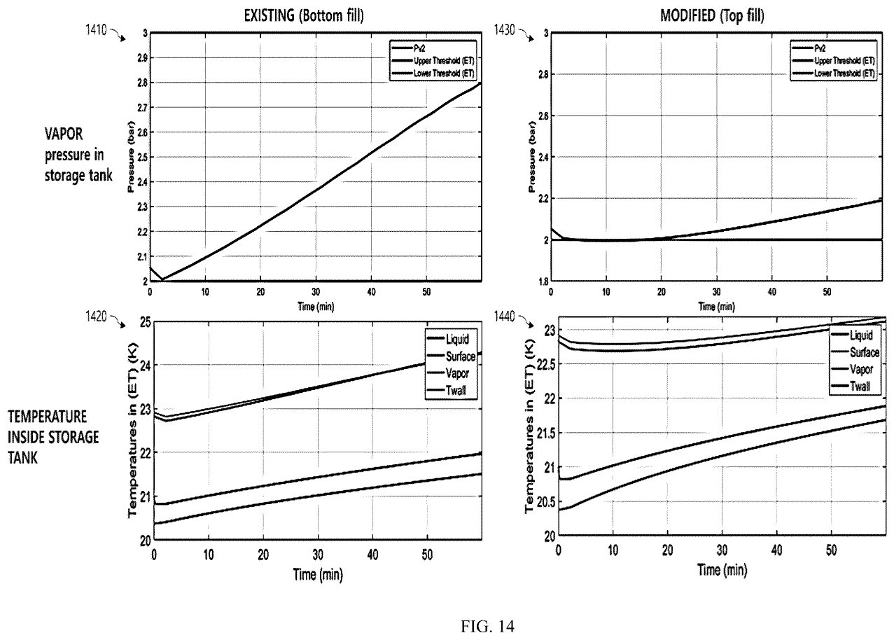

FIG. 14 illustrates the results of application of the top fill method compared to the bottom fill method according to some embodiments.

Referring to FIG. 14, graphs 1410, 1420, 1430, and 1440 showing the application results of the top fill method compared to the bottom fill method in terms of vapor pressure and temperature are illustrated.

Regarding to the application results of the top fill, a simulation was conducted in the form of comparing the existing bottom fill to check the behavior of the model to which the balance formula modified to be suitable for the top fill method. In the corresponding scenario, a simulation of filling liquid hydrogen from a trailer to a storage tank was conducted for 60 minutes, with the storage tank being approximately 50% filled with liquid hydrogen.

When looking at graphs 1410, 1420, 1430, and 1440, as a result of the simulation, it can be seen that the liquid hydrogen filled into the upper end of the storage tank cools and condenses the vapor due to the effect of top fill, thereby suppressing an increase rate of the pressure and temperature of the vapor in the storage tank.

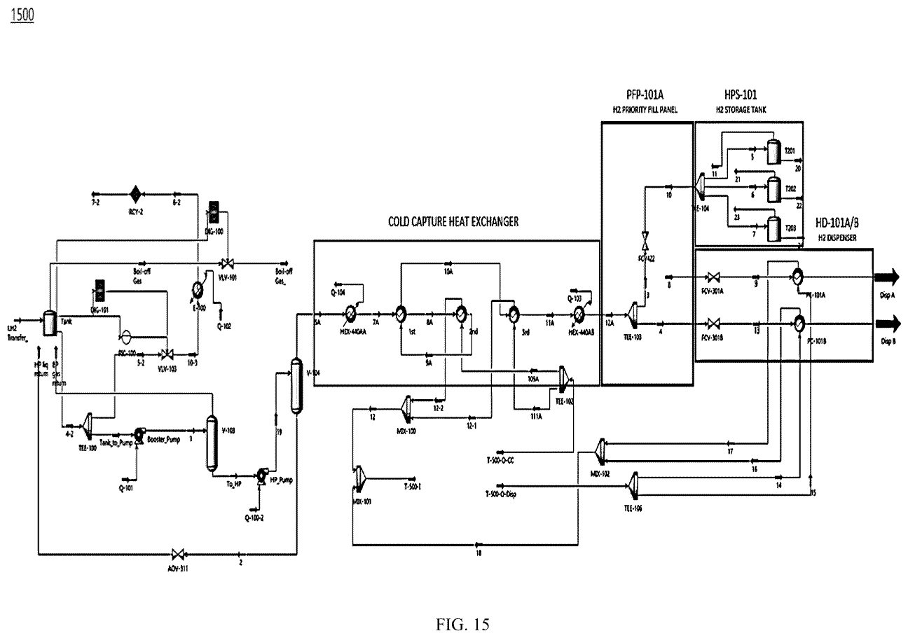

FIG. 15 illustrates a steady-state simulation model for a liquid hydrogen refueling system according to some embodiments.

Referring to FIG. 15, a structure 1500 of a steady-state simulation model for a liquid hydrogen refueling system is illustrated.

In constructing a simulation model for the entire system, in the case of constructing a steady-state simulation model, the structure 1500 was modeled using Aspen HYSYS, which is a process simulation program. The structure 1500 is configured by reflecting actual operating conditions with respect to significant main devices.

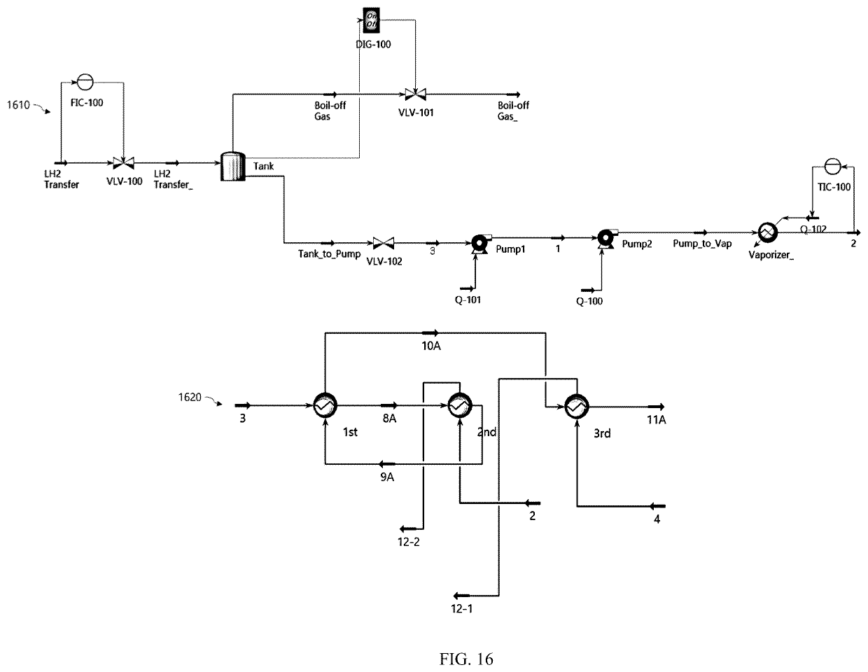

FIG. 16 illustrates a dynamic-state simulation model for the liquid hydrogen refueling system according to some embodiments.

Referring to FIG. 16, in the dynamic-state simulation model for the liquid hydrogen refueling system, a form 1610 obtained by simplifying a storage tank and a cryo-pump and a form 1620 obtained by simplifying a vaporizer are illustrated.

Regarding constructing a dynamic simulation model, a steady-state model was converted to a dynamic simulation model based on the steady-state model in order to determine changes in process variables (temperature, pressure, flow rate, etc.) over time when a fault situation occurs in a part of this system that is difficult to interpret with a precise tank model. In order to conduct a smooth dynamic simulation using Aspen HYSYS, it is necessary to simplify the modeling by focusing on core devices in the system or by dividing the system into specific parts, and various fault scenarios were simulated based on this.

The form 1610 represents an Aspen HYSYS model obtained by simplifying the storage tank and cryo-pump, and the form 1620 represents an Aspen HYSYS model obtained by simplifying the vaporization part. In the case of this process, since there is no recycle loop between core devices while the return valve is turned off, simulation is possible for each zone. That is, it is a form that allows for integrated simulation by simply substituting an output from one zone only as an input in a subsequent zone.

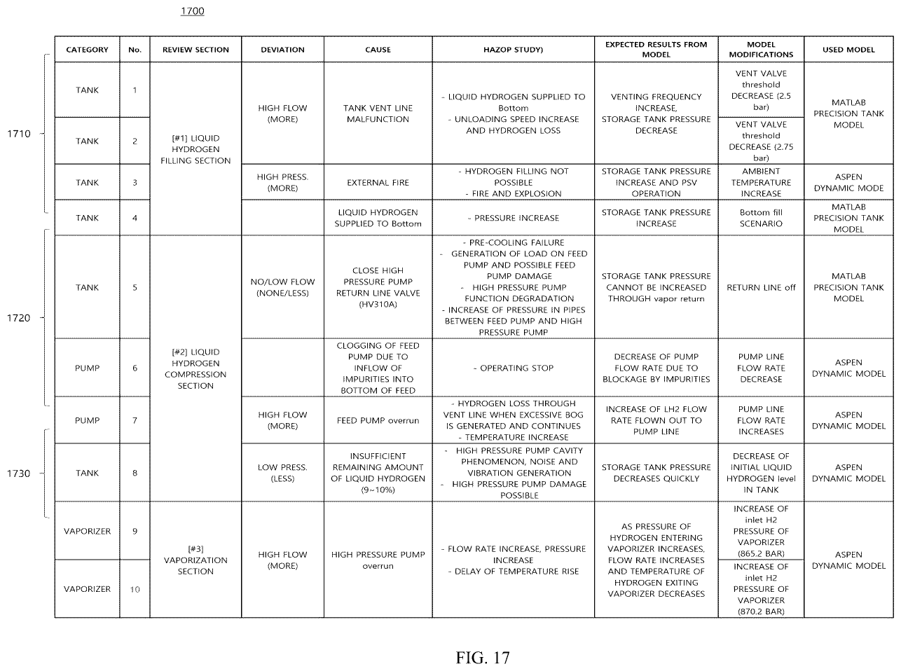

FIG. 17 illustrates fault condition scenarios for a liquid hydrogen refueling system according to some embodiments.

Referring to FIG. 17, a table 1700 illustrating fault condition scenarios for the liquid hydrogen refueling system are illustrated. The table 1700 may include a first fault scenario 1710 that occurs during a process in which liquid hydrogen is filled from a trailer tank to a storage tank, a second fault scenario 1720 that occurs during a process in which the liquid hydrogen is transferred from the storage tank to a cryo-pump, and a third fault scenario 1730 that occurs during a process in which the liquid hydrogen delivered through the cryo-pump is vaporized in a heat exchange vaporizer.

Regarding the generation of normal and fault scenarios, a normal scenario that will serve as a reference was generated in order to determine how changes in the process occur when a fault situation occurs. In the case of the MATLAB precision tank model, the normal scenario was taken as a scenario in which liquid hydrogen is filled from a tank lorry up to approximately 90%, which is the maximum capacity, with the storage tank approximately 80% filled, and then flown out to the pump without being filled any more into storage tank. In the case of the Aspen HYSYS model, the normal scenario was set differently for each scenario, and this will be discussed in detail below in the results of applying a fault detection algorithm.

In addition, the fault scenarios were generated as follows based on the causes and results of various fault situations that can occur in an actual system. They are divided as follows according to the zone where the fault occurs. [#1] Liquid hydrogen filling section: From tank lorry to liquid hydrogen storage tank, [#2] Liquid hydrogen compression section: From liquid hydrogen storage tank to feed pump and then to rear end of high pressure pump/front end of vaporizer, and [#3] Vaporization section: From front end of heat exchanger to rear end of the vaporizer. The [#1] liquid hydrogen filling section may correspond to the first fault scenario 1710, the [#2] liquid hydrogen compression section may correspond to the second fault scenario 1720, and the [#3] vaporization unit may correspond to the third fault scenario 1730.

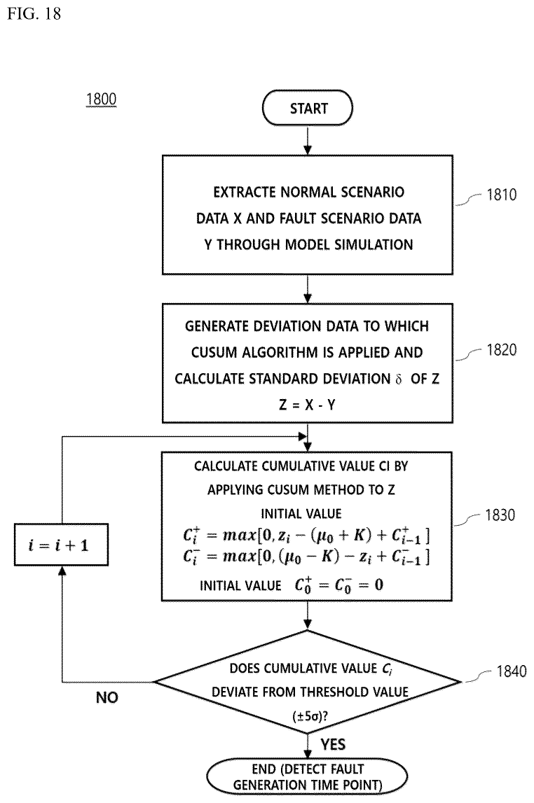

FIG. 18 illustrates an outline of a fault detection algorithm for a liquid hydrogen refueling system according to some embodiments

Referring to FIG. 18, an outline 1800 of the fault detection algorithm for the liquid hydrogen refueling system is illustrated. The outline 1800 may be composed of steps 1810, 1820, 1830, and 1840.

In step 1810, normal scenario data x and fault scenario data y may be extracted through model simulation. In step 1820, deviation data z=x-y to which a CUSUM algorithm is applied may be generated, and a standard deviation σ of z may be calculated. In step 1830, a cumulative value Cᵢ may be calculated by applying the CUSUM method to z. In step 1840, it may be determined whether the cumulative value Cᵢ deviates from a threshold of approximately ±5σ. When it is determined that the cumulative value Cᵢ does not deviate (NO), it may proceed to a next cumulation step according to the CUSUM method (i=i+1). When it is determined that the cumulative value Cᵢ deviates (YES), it may be detected that a fault has occurred in the liquid hydrogen refueling system.

In step 1830, Cᵢ⁺ and Cᵢ⁻ represent the upper and lower end cumulative sums, respectively, and Cᵢ⁺ is used when finding a positive mean shift and Cᵢ⁻ is used when finding a negative mean shift. The target value μ₀ is 0, and the reference value K is set to approximately 0.5 σ, which is a commonly used value.

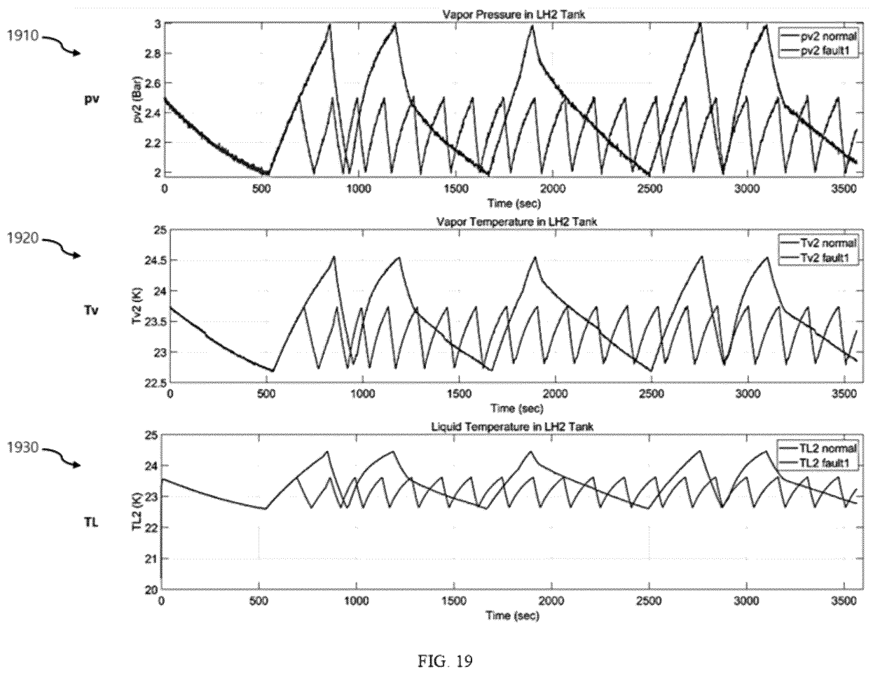

FIG. 19 illustrates process variables measured in a simulation model according to some embodiments.

Referring to FIG. 19, graphs 1910, 1920, and 1930 showing process variables measured in the simulation model are illustrated. The graphs 1910, 1920, and 1930 may represent vapor pressure pv, vapor temperature Tv, and liquid temperature TL, respectively.

In the present invention, faults are detected using the differences in vapor pressure pv, vapor temperature Tv, and liquid temperature TL in the storage tank between a normal scenario and each fault scenario. The reason for setting in this way is that pressure and temperature are measurable process variables that can identify changes when a safety issue occurs in the liquid hydrogen refueling system, which is a target system. In addition, random noise was applied to data in order to simulate a situation similar to an actual system.

For example, when comparing the pv, Tv, and TL in the storage tank for the normal scenario (blue line) and a fault scenario #1 (orange line), the graphs 1910, 1920, and 1930 are as follows. The blue line corresponds to normal data, and the orange line corresponds to faulty data. Since there is a difference between a value of normal data and a value of faulty data value, fault detection is possible by utilizing the difference. Since the change tendencies of pressure and temperature were shown to be the same, only the results through pressure will be drawn in the future scenarios. However, in the case of fault scenarios #9 and #10 of the third fault scenario 1730 of the table 1700 of FIG. 17, the temperature results were shown because the scenarios were generated and simulated by changing the pressure.

In the graphs 1910, 1920, and 1930, the blue line is normal data, and the orange line is faulty data. It can be seen that the faulty data value is larger than the normal data value at the fault detection point in time. Deviation data to which CUSUM is applied was treated as the difference between the two scenario values. The threshold, or upper control limit/lower control limit (UCL/LCL) was set to approximately ±5σ, and finally, the cumulative sum of the data was plotted using the CUSUM function built into MATLAB. The detection point in time was set to a point in time when approximately 10 seconds passed, not immediately after the deviation data exceeded the threshold in consideration of a certain amount of time delay.

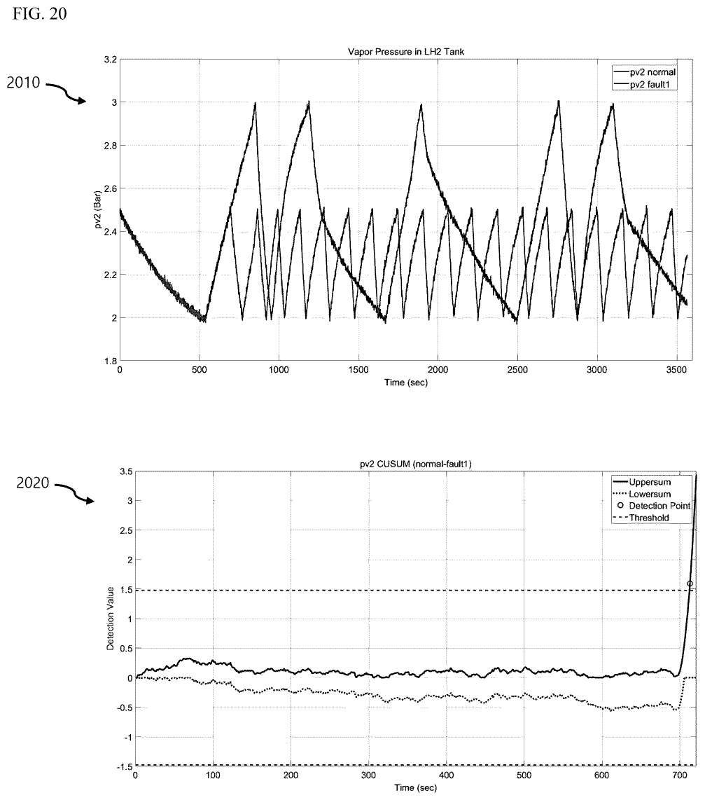

FIGS. 20 to 29 illustrate a process of detecting a fault condition in fault condition scenarios according to some embodiments.

Referring to FIG. 20, a graph 2010 representing the difference between normal data and faulty data for the fault scenario #1 and a graph 2020 representing the result of applying CUSUM are illustrated.

The fault scenario #1 is a scenario in which a gaseous hydrogen vent line in the storage tank malfunctions and thus the amount of gaseous hydrogen vented increases. In this case, the number of vents and the amount of gaseous hydrogen vented increase, and the pressure in the storage tank decreases. In the case of the normal scenario, a vent valve is set to open at the time when the pressure in the storage tank reaches approximately 3 bar, and in this scenario, the valve is set to open when the pressure in the storage tank reaches approximately 2.5 bar due to the malfunction of the vent line. In the beginning, there is almost no difference between the normal data and the faulty data, but as a fault situation occurs at a certain point in time, a difference gradually occurs between the two data, and when a cumulative value of the difference exceeds a set threshold, a fault is detected.

The red solid line in the graph 2020 indicates an upper cumulative value, and the blue dotted line indicates a lower cumulative value. Since the deviation data is set as (normal data—faulty data), when a fault situation occurs and the normal data value becomes larger than the faulty data value, the upper cumulative value exceeds the threshold, as shown in the result below, and the point in time when the fault situation occurs is detected. Since it was previously shown that the change tendencies between pressure and temperature are the same, the fault situation detection is possible only with pressure information. As a result of applying the fault detection algorithm, it was confirmed that the fault situation was detected at the point in time of approximately 710 s.

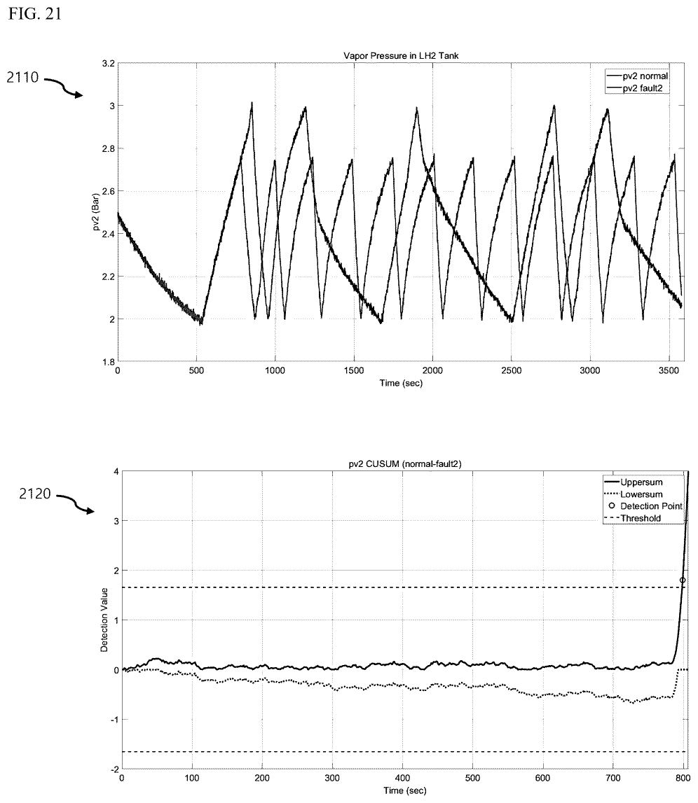

Referring to FIG. 21, a graph 2110 representing the difference between normal data and faulty data for the fault scenario #2 and a graph 2120 representing the result of applying CUSUM are illustrated.

The fault scenario #2 is a scenario in which the gaseous hydrogen vent line in the storage tank malfunctions and thus the amount of gaseous hydrogen vented increases, similar to the scenario #1. In this scenario, the valve is set to open when the vent line malfunctions and the pressure in the storage tank reaches approximately 2.75 bar to compare the fault detection point in time with the scenario #1. As a result of applying the fault detection algorithm, it was confirmed that the fault was detected at a point in time when about 797 s passed, and it can be seen that the fault was detected slightly after the simulation had progressed further than in the scenario #1.

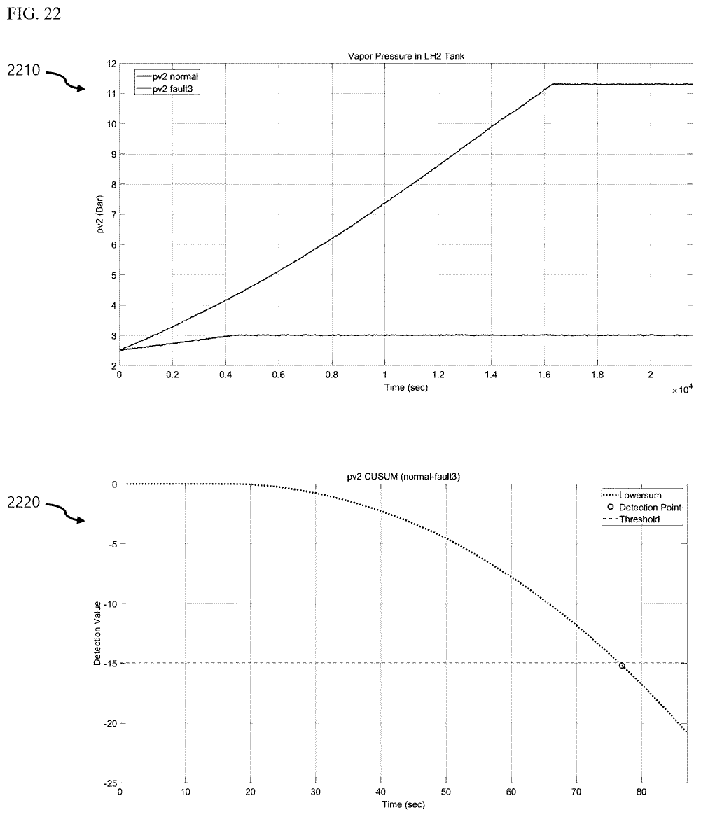

Referring to FIG. 22, a graph 2210 representing the difference between normal data and faulty data for the fault scenario #3 and a graph 2220 representing the result of applying CUSUM are illustrated.

The fault scenario #3 is a scenario in which a fire occurs outside a liquid hydrogen storage tank and thus the temperature around the storage tank rapidly increases. In the case of normal scenario, the temperature around the storage tank is approximately 25° C., and when the pressure in the storage tank reaches 3 bar, the vent valve opens to maintain the pressure in the storage tank at approximately 3 bar. In contrast, this scenario corresponds to a situation where a fire occurs outside and the temperature around the storage tank rises to approximately 591.9° C. (865 K), and a significant amount of heat enters the storage tank from the outside.

This vaporizes a large amount of liquid hydrogen inside the storage tank, which causes the pressure in the storage tank to rise rapidly. In addition, in this case, an overpressure relief valve (SV-1A/B; Pressure Safety Valve) of the storage tank, not the vent valve that maintains approximately 3 bar, operates at the design pressure of approximately 11.3 bar. A discharge flow rate of a pressure safety valve is designed to be approximately 293 kg/h. The pressure safety valve is designed to have sufficient discharge flow rate, and thus, it can be seen that the pressure is maintained at approximately 11.3 bar. As a result of applying the fault detection algorithm, it was confirmed that the fault was detected at a point in time when approximately 76 seconds passed after the fire occurred.

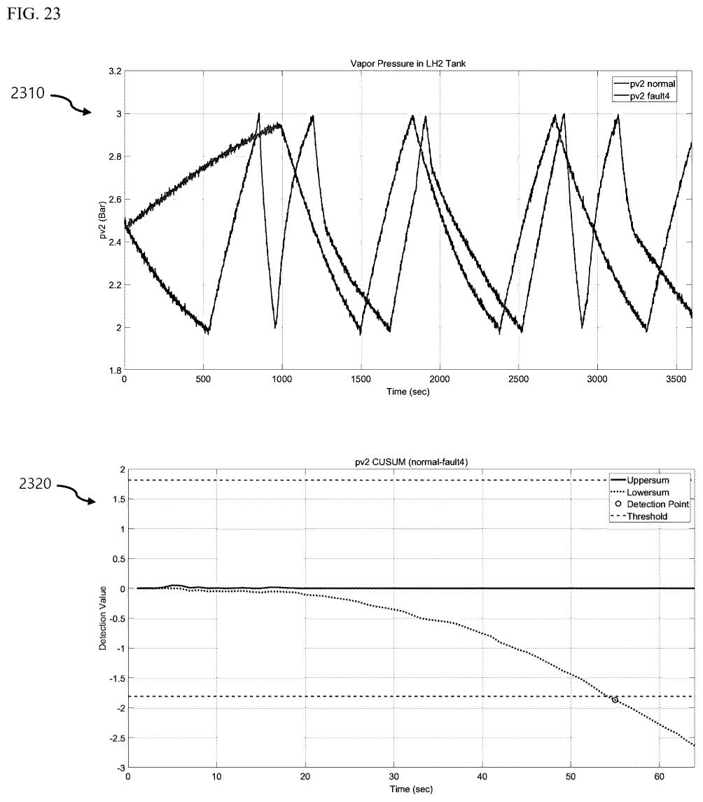

Referring to FIG. 23, a graph 2310 representing the difference between normal data and faulty data for the fault scenario #4 and a graph 2320 representing the result of applying CUSUM are illustrated.

The fault scenario #4 is a scenario in which liquid hydrogen is filled into the storage tank using the bottom fill method, in which liquid hydrogen is injected into the lower end part of the tank, rather than the top fill method, in which liquid hydrogen is injected into into the upper end part of the tank when filling the storage tank from the tank lorry. Basically, when filling the storage tank in this system with liquid hydrogen, the top fill method is used. The top fill method has an economic advantage in that the liquid hydrogen filled into the upper end part of the storage tank during filling is sprayed and sinks to a liquid surface of the tank, and in this process, it has the effect of cooling the surrounding gaseous hydrogen, which ultimately suppresses the pressure increase in the storage tank.

On the other hand, when the bottom fill method is used, the liquid level in the storage tank continuously rises during the process of filling the liquid hydrogen into the storage tank, which leads to an increase the pressure in the storage tank. In the case of the normal scenario, the liquid hydrogen is filled into the storage tank by the top fill method, and in this scenario, the result of filling by the bottom fill method was shown. As a result of applying the fault detection algorithm, it was confirmed that the fault situation was detected at a point in time when approximately 56 seconds passed after the fault occurred.

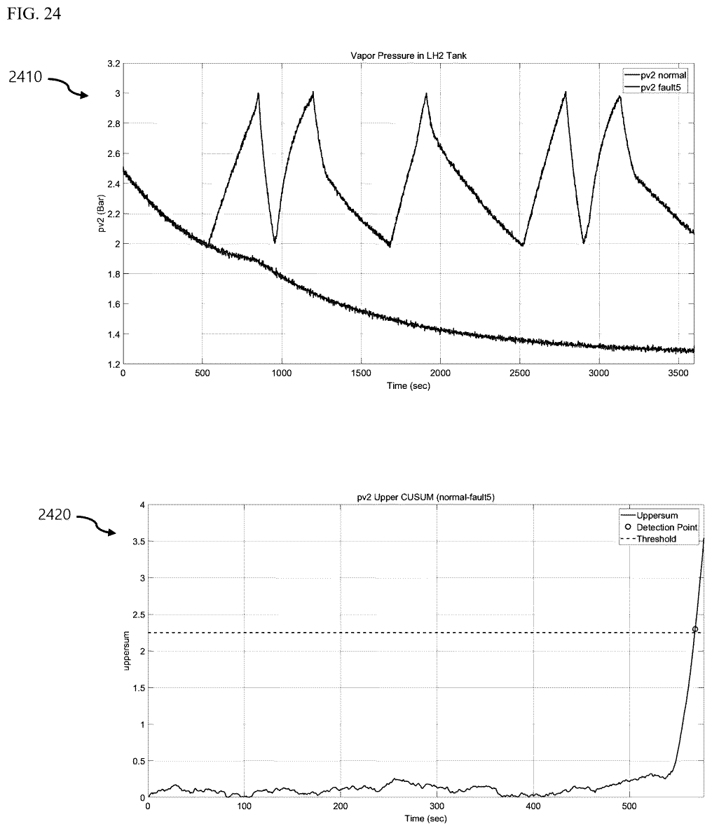

Referring to FIG. 24, a graph 2410 representing the difference between normal data and faulty data for the fault scenario #5 and a graph 2420 representing the result of applying CUSUM are illustrated.

The fault scenario #5 is a fault situation in which a valve of a line through which gaseous hydrogen generated from a high pressure pump is returned to the storage tank is closed, the pressure in the storage tank is too low, and thus vapor return, which is for preventing problems in transferring liquid hydrogen to the pump, is not possible. In this case, there is a possibility that the pump may be damaged due to a load generated on the pump, the function of the pump may be degraded, and the pressure in pipes between the pumps increases.

Focusing on the storage tank, the pressure tends to continuously decrease because the vapor return/recovery does not occur and the pressure cannot increase. As a result of applying the fault detection algorithm, it was confirmed that a fault situation was detected at a point in time when approximately 568 s passed. In this case, it can be considered as a normal operating range until the pressure reaches approximately 2 bar.

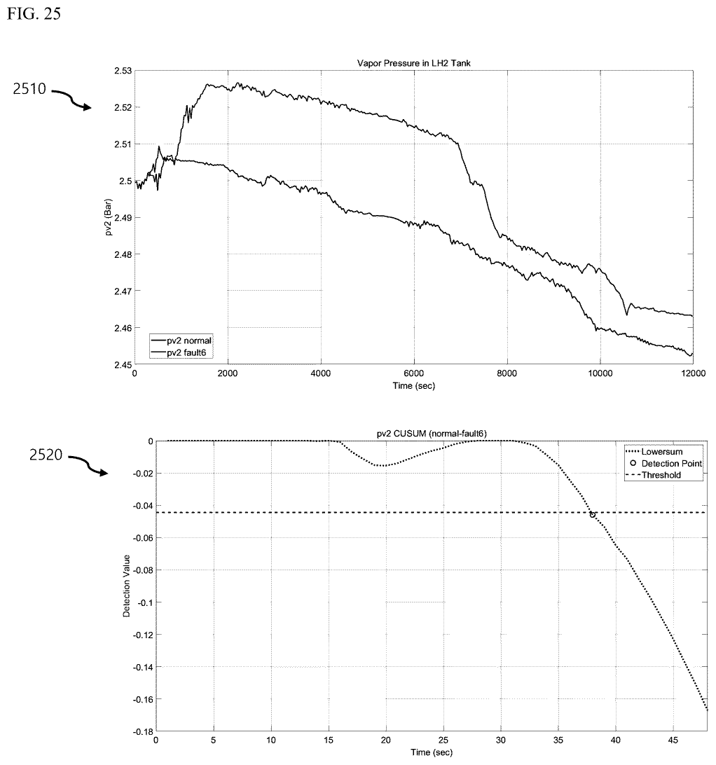

Referring to FIG. 25, a graph 2510 representing the difference between normal data and faulty data for the fault scenario #6 and a graph 2520 representing the result of applying CUSUM are illustrated.

The fault scenario #6 is a scenario in which impurities are introduced into a lower end portion of a feed pump and a part thereof is blocked. In this case, the scenario corresponds to a situation in which since a part of the pump is blocked, a flow rate smaller than approximately 120 kg/h, which is a normal operating flow rate, flows, and the operation of the process can be stopped.

In this scenario, the simulation was conducted at a flow rate of approximately 114 kg/h, which is approximately 5% smaller than the existing flow rate of approximately 120 kg/h.

In the case of the normal scenario, the pressure of the tank decreases as the liquid hydrogen flows out to the pump line. However, it can be seen that a decrease rate in tank pressure also tends to decrease if the liquid hydrogen flows out at a smaller flow rate as in this scenario. As a result of applying the fault detection algorithm, it was confirmed that the fault situation was detected at a point in time when approximately 38 s passed.

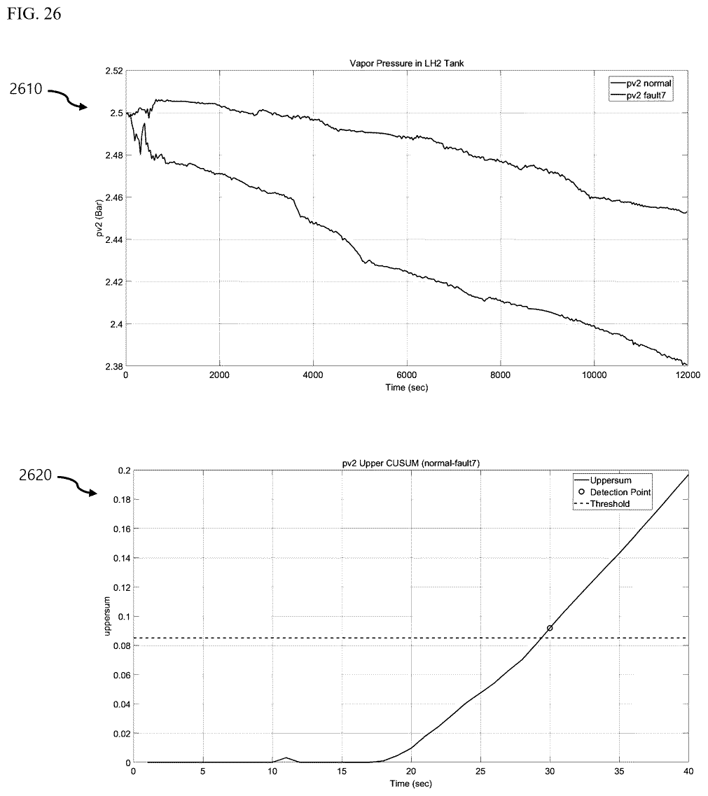

Referring to FIG. 26, a graph 2610 representing the difference between normal data and faulty data for the fault scenario #7 and a graph 2620 representing the result of applying CUSUM are illustrated.

The fault scenario #7 is a scenario in which the liquid hydrogen is transferred at a flow rate greater than the existing pump flow rate of approximately 120 kg/h due to an overrun caused by a malfunction of the feed pump. In this case, as the flow rate increases, the pressure also increases, resulting in excessive BOG generation, which, if continued, results in hydrogen loss through the vent line and an increase in temperature. As the pump overruns, a larger flow rate than the normal operating flow rate of approximately 120 kg/h flows. In this scenario, the simulation was conducted with a flow rate of approximately 240 kg/h, which is twice the existing flow rate of approximately 120 kg/h, to see clear results.

In the case of the normal scenario, the pressure in the tank decreases as the liquid hydrogen flows out to the pump line. However, when the liquid hydrogen flows out at a larger flow rate, as in this scenario, the pressure in the tank tends to decrease more rapidly and significantly. As a result of applying the fault detection algorithm, it was confirmed that the fault situation was detected at the point in time when approximately 30 s passed.

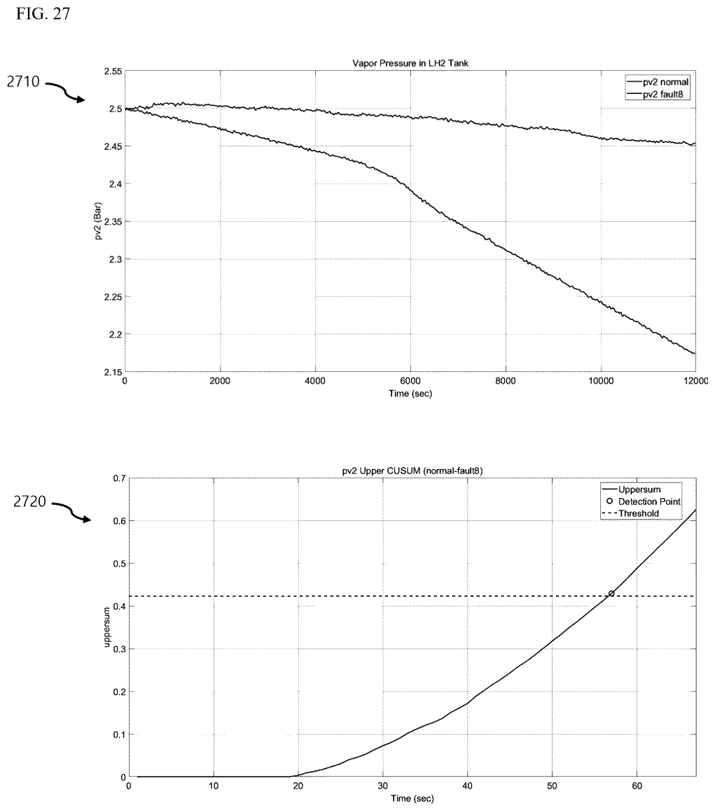

Referring to FIG. 27, a graph 2710 representing the difference between normal data and faulty data for the fault scenario #8 and a graph 2720 representing the result of applying CUSUM are illustrated.

The fault scenario #8 is a scenario in which the residual amount of liquid hydrogen in the storage tank is insufficient. In this case, gas may be generated during the process of being transferred to the pump, which may damage the pump by causing cavitation and noise vibration in the pump. In the case of the normal scenario, liquid hydrogen is transferred to the pump line when approximately 90% of the total volume of the tank is filled. In this scenario, the simulation was conducted in a situation where only approximately 10% of the total volume was filled. When the liquid level in the storage tank is low, the pressure tends to decrease at a faster rate. As a result of applying the fault detection algorithm, it was confirmed that the fault situation was detected at the point in time when approximately 58 s passed.

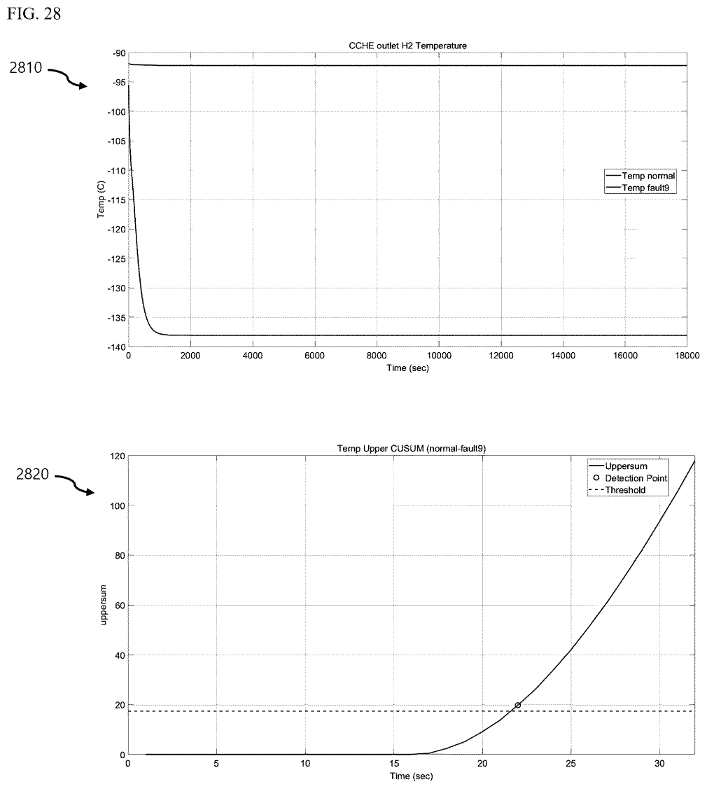

Referring to FIG. 28, a graph 2810 representing the difference between normal data and faulty data for the fault scenario #9 and a graph 2820 representing the result of applying CUSUM are illustrated.

The fault scenario #9 is a scenario in which a high pressure pump malfunctions and discharges hydrogen at a higher pressure. In the case of the normal scenario, hydrogen passed through the high pressure pump is discharged at a pressure of approximately 860.2 bar and enters the vaporizer, but if the high pressure pump overruns, the hydrogen is discharged at a pressure higher than that pressure. As the pressure increases in this way, the flow rate also increases, which delays the temperature increase of the hydrogen flowing out of the vaporizer.

Due to the characteristics of the vaporizer, which includes multiple heat exchangers to raise the low temperature hydrogen temperature to approximately −200° C., if a larger amount of hydrogen passes through the heat exchanger in a situation where the flow rate of the heat exchange fluid is fixed, the temperature rises less than in the normal scenario. Therefore, for this reason, if the pressure of the hydrogen entering the vaporizer is high, the temperature of the hydrogen flowing out of the vaporizer is lower. In this scenario, the change in temperature of the hydrogen flowing out of the vaporizer when the pressure of the hydrogen passed through the high pressure pump is approximately 865.2 bar, which is higher than in the normal scenario was confirmed, and it can be seen that the hydrogen temperature in this scenario is lower. As a result of applying the fault detection algorithm, it was confirmed that the fault situation was detected at a point in time when approximately 22 s passed.

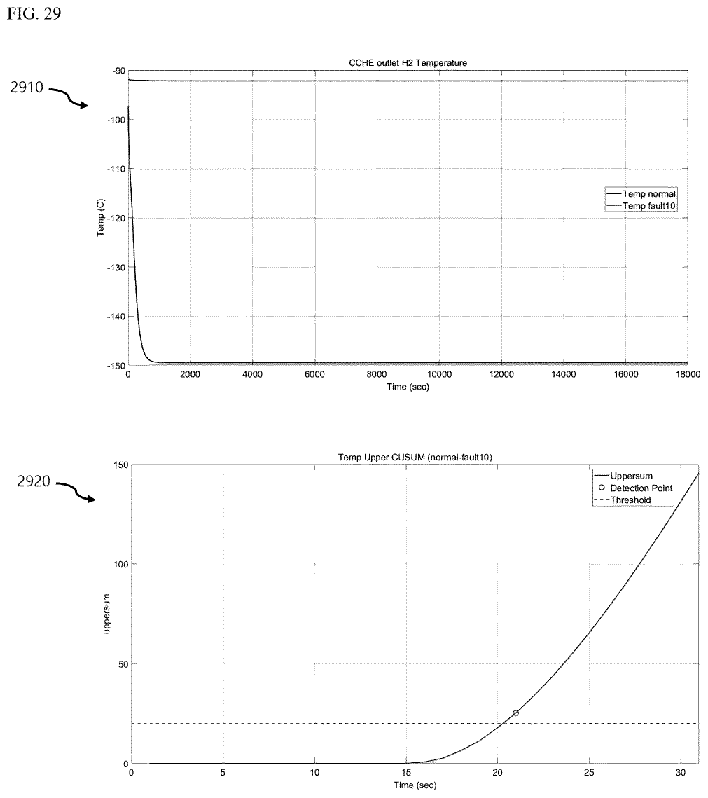

Referring to FIG. 29, a graph 2910 representing the difference between normal data and faulty data for the fault scenario #10 and a graph 2920 representing the result of applying CUSUM are illustrated.

The fault scenario #10 is a scenario in which the high pressure pump malfunctions and discharges hydrogen at a higher pressure, similar to the scenario #9. In this scenario, the change in temperature of the hydrogen flowing out of the vaporizer when the pressure of the hydrogen passing through the high pressure pump was approximately 870.2 bar, which was higher than in the normal scenario, was confirmed, and it can be seen that the hydrogen temperature in this scenario is lower. In addition, since the pressure higher than the pump discharge pressure of approximately 865.2 bar in the scenario #9 was simulated, it was confirmed that the flow rate was higher and the temperature was lower. As a result of applying the fault detection algorithm, it was confirmed that the fault situation was detected at a point in time when approximately 22 s passed.

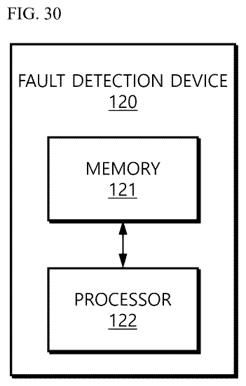

FIG. 30 illustrates a model-based fault detection device for a liquid hydrogen refueling system using a cumulative sum method according to some embodiments.

Referring to FIG. 30, a model-based fault detection device 120 for a liquid hydrogen refueling system using a cumulative sum method may include a memory 121 and a processor 122. However, the model-based fault detection device 120 is not limited thereto, and some components may be omitted from the model-based fault detection device 120, or other general-purpose components may be further included in the model-based fault detection device 120.

The memory 121 may have an architecture for storing various instructions, computer programs, software, mobile applications, or data processed by the model-based fault detection device 120. For example, the memory 121 may be implemented as a nonvolatile memory such as a ROM, a PROM, an EPROM, an EEPROM, a flash memory, a PRAM, an MRAM, an

RRAM, an FRAM, etc., or a volatile memory such as a DRAM, an SRAM, an SDRAM, etc., and may be implemented in the form of an HDD, an SSD, an SD, a Micro-SD, or a combination thereof.

The processor 122 may have an architecture for performing processing required for the operation of the model-based fault detection device 120. The processor 122 may be implemented as an array of multiple logic gates for processing various operations or a general-purpose microprocessor, and may be composed of a single processor or multiple processors. For example, the processor 122 may be implemented in the form of at least one of a microprocessor, a CPU, a GPU, and an AP.

The processor 122 may be configured to obtain process variables inside the liquid hydrogen storage system 100 based on a simulation model for the liquid hydrogen storage system 100 by executing instructions stored in the memory 121. For example, the process variables inside the liquid hydrogen storage system may include vapor pressure pv, vapor temperature Tv, liquid temperature TL, etc., and for more details on this, reference may be made to FIG. 19.

The processor 122 may be configured to obtain normal scenario data and fault scenario data of the process variables by using the steady-state model and the dynamic state model for the liquid hydrogen storage system 100 by executing instructions stored in the memory 121. Regarding the steady-state model and dynamic-state model for the liquid hydrogen storage system 100, reference may be made to FIGS. 15 and 16 described above.

The processor 122 may be configured to calculate the upper end cumulative sum index Cᵢ⁺ and the lower end cumulative sum index Cᵢ⁻ by applying the cumulative sum (CUSUM) control method to deviation data corresponding to the difference between the normal scenario data and the fault scenario data by executing instructions stored in the memory 121. For the CUSUM control method, reference may be made to FIG. 3 described above, and for the calculation of the upper end CUSUM index Cᵢ⁺ and the lower end CUSUM index Cᵢ⁺, reference may be made to FIG. 18 described above.

The processor 122 may be configured to detect whether the liquid hydrogen storage system 100 is faulty by comparing the upper end CUSUM index Cᵢ⁺ and the lower end CUSUM index Cᵢ⁻ with a threshold by executing instructions stored in the memory 121. The threshold may be ±5σ, and the specific numerical value may be changed as needed.

According to an embodiment, the simulation model for the liquid hydrogen storage system 100 may be configured to model mass balance and energy balance for a process of transferring liquid hydrogen from a trailer tank to a storage tank and a process of transferring the liquid hydrogen from the storage tank to a cryo-pump. For more details on this, reference may be made to the FIG. 8 described above.

According to an embodiment, the simulation model for the liquid hydrogen storage system 100 may be configured to further model mass balance and energy balance for a boil-off gas (BOG) vent process for venting boil-off gas generated in the storage tank and a vapor return process for returning hydrogen vapor to the storage tank to maintain hydrogen vapor pressure in the storage tank. For more details on this, reference may be made to FIG. 11 described above.

According to an embodiment, the simulation model for the liquid hydrogen storage system 100 may be configured to model the storage tank based on a horizontal storage tank of which a side surface of a cylinder faces the ground and upper and lower surfaces of the cylinder are perpendicular to the ground based on a top fill method in which liquid hydrogen is filled from the trailer tank to an upper end part of the storage tank. For the horizontal storage tank, reference may be made to FIG. 7 described above, and for the top fill method, reference may be made to FIGS. 11 to 14 described above.

According to an embodiment, the normal scenario data according to the steady-state model represents a scenario in which the liquid hydrogen supplied from the trailer tank is flown out to the cryo-pump after being filled up to the maximum capacity in the storage tank, and the dynamic state model may be configured to model a first fault scenario that occurs in a process in which the liquid hydrogen is filled from the trailer tank to the storage tank, a second fault scenario that occurs in a process in which the liquid hydrogen is delivered from the storage tank to the cryo-pump, and a third fault scenario that occurs in a process in which the liquid hydrogen delivered through the cryo-pump is vaporized in a heat exchange vaporizer. For the normal scenario data according to the steady-state model, reference may be made to FIG. 15 described above. For the first, second and third scenarios 1710, 1720, and 1730, reference may be made to FIG. 17 described above.

According to an embodiment, the first fault scenario may include a scenario in which a vent threshold of a BOG vent process for venting boil-off gas (BOG) generated within the storage tank decreases, a scenario in which an external fire occurs, and a scenario in which a top fill method is changed to a bottom fill method, the second fault scenario may include a scenario in which a return line valve is closed in a vapor return process for returning hydrogen vapor to the storage tank, a scenario in which a flow rate of the liquid hydrogen delivered from the storage tank to the cryo-pump decreases due to impurity blockage, a scenario in which a flow rate of the liquid hydrogen delivered from the storage tank to the cryo-pump increases, and a scenario in which a residual amount of the liquid hydrogen within the storage tank is insufficient, and the third fault scenario may include a scenario in which pressure at which the liquid hydrogen enters the heat exchange vaporizer from the cryo-pump increases. For more details on the first, second and third scenarios 1710, 1720, and 1730, reference may be made to FIGS. 20 to 29 described above.

According to an embodiment, the process variables used to obtain the normal scenario data and the fault scenario data may include hydrogen vapor pressure, hydrogen vapor temperature, and liquid hydrogen temperature measured in a storage tank of the liquid hydrogen storage system, and the processor may be configured to apply a cumulative sum CUSUM control method to the deviation data regarding the hydrogen vapor pressure, the hydrogen vapor temperature, and the liquid hydrogen temperature to calculate an upper end cumulative sum index Cᵢ⁺ and a lower end cumulative sum index Cᵢ⁻. For the process of applying the cumulative sum (CUSUM) control method using the hydrogen vapor pressure pv, hydrogen vapor temperature Tv, and liquid hydrogen temperature TL, reference may be made to FIGS. 18 to 20 described above.

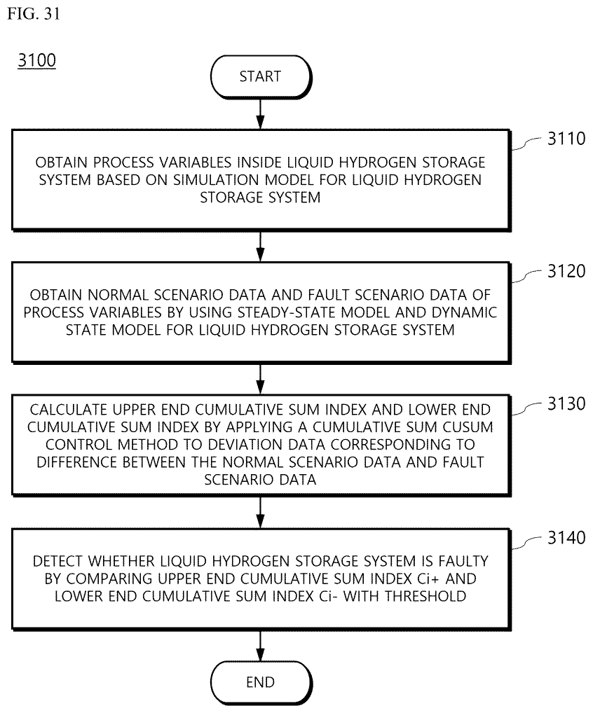

FIG. 31 illustrates a model-based fault detection method for a liquid hydrogen refueling system using a cumulative sum method according to some embodiments.

Referring to FIG. 31, a model-based fault detection method 3100 for a liquid hydrogen refueling system using a cumulative sum method may include steps 3110 to 3140. However, the model-based fault detection method is not limited thereto, and some steps may be omitted or other general steps may be added, and the steps of the model-based fault detection method 3100 may be executed in a different order from the illustrated order.

The model-based fault detection method 3100 for a liquid hydrogen refueling system using a cumulative sum method may be composed of steps that are processed in time series in the model-based fault detection device 120 of the liquid hydrogen refueling system using a cumulative sum method. Therefore, even if the content is omitted below, the content described above for the fault detection device 120 may be equally applied to the model-based fault detection method 3100.

Steps 3110 to 3140 of the model-based fault detection method 3100 for the liquid hydrogen refueling system using the cumulative sum method may be performed by using the memory 121 and the processor 122 of the model-based fault detection device 120 of the liquid hydrogen refueling system using the cumulative sum method.

In step 3110, the model-based fault detection device 120 of the liquid hydrogen refueling system using the cumulative sum method may obtain process variables inside the liquid hydrogen storage system based on a simulation model for the liquid hydrogen storage system.

In step 3120, the model-based fault detection device 120 of the liquid hydrogen refueling system using the cumulative sum method may obtain normal scenario data and fault scenario data of the process variables by using a steady-state model and a dynamic state model for the liquid hydrogen storage system.

In step 3130, the model-based fault detection device 120 of the liquid hydrogen refueling system using the cumulative sum method may calculate an upper end cumulative sum index Cᵢ⁺ and a lower end cumulative sum index Cᵢ⁻ by applying a cumulative sum CUSUM control method to deviation data corresponding to a difference between the normal scenario data and the fault scenario data.

In step 3140, the model-based fault detection device 120 of the liquid hydrogen refueling system using the cumulative sum method may detect whether the liquid hydrogen storage system is faulty by comparing the upper end cumulative sum index Cᵢ⁺ and the lower end cumulative sum index Cᵢ⁻ with a threshold.

According to an embodiment, the model-based fault detection method 3100 for the liquid hydrogen refueling system using the cumulative sum method may be implemented in the form of a computer program stored in a computer-readable storage medium. That is, the computer program may include instructions for implementing the model-based fault detection method 3100, and the instructions of the program may be stored in a computer-readable storage medium. The computer program may include a mobile application.

According to an embodiment, the computer-readable storage medium may include hardware devices specifically configured to store and execute computer program instructions such as magnetic media such as hard disks, floppy disks, and magnetic tapes, optical media such as CD-ROMs, DVDs, magneto-optical media such as floptical disks, ROMs, RAMs, flash memories, etc. The computer program instructions may include machine language codes generated by a compiler and high-level language codes that can be executed by a computer using an interpreter, etc. According to embodiments of the present invention, before constructing and operating an actual liquid hydrogen refueling station, modeling of the relevant process is performed in advance to ensure economic efficiency and safety through simulation, thereby preventing various safety accidents that may occur in the liquid hydrogen refueling system.

The technical effects according to embodiments of the present invention are not limited to the effects mentioned above, and other effects not mentioned will be clearly understood by those skilled in the art according to the disclosure of this document.

Although the model-based fault detection method and device algorithm for liquid hydrogen refueling system using cumulative sum method, and the computer program have been described with reference to the specific embodiments, they are not limited thereto. Therefore, it will be readily understood by those skilled in the art that various modifications and changes can be made thereto without departing from the spirit and scope of the present invention defined by the appended claims.

Although the embodiments of the present invention have been described in detail above, the scope of rights according to the present invention is not limited thereto, and various modifications and improvements made by those skilled in the art using the basic concept of the present invention described in the following claims should also be interpreted as being included in the scope of rights according to the present invention.

What is claimed is:

1. A model-based fault detection device for a liquid hydrogen refueling system using a cumulative sum method, the device comprising:
a memory that stores instructions; and
a processor configured to, by executing the instructions,
obtain process variables inside a liquid hydrogen storage system based on a simulation model for the liquid hydrogen storage system,
obtain normal scenario data and fault scenario data of the process variables by using a steady-state model and a dynamic state model for the liquid hydrogen storage system,
calculate an upper end cumulative sum index Cᵢ⁺ and a lower end cumulative sum index Cᵢ⁻ by applying a cumulative sum (CUSUM) control method to deviation data corresponding to a difference between the normal scenario data and the fault scenario data, and
detect whether the liquid hydrogen storage system is faulty by comparing the upper end cumulative sum index Cᵢ⁺ and the lower end cumulative sum index Cᵢ⁻ with a threshold.

2. The device of claim 1,
wherein the simulation model for the liquid hydrogen storage system is configured to model mass balance and energy balance for a process of transferring liquid hydrogen from a trailer tank to a storage tank and a process of transferring the liquid hydrogen from the storage tank to a cryo-pump.

3. The device of claim 2,
wherein the simulation model for the liquid hydrogen storage system is configured to further model mass balance and energy balance for a boil-off gas (BOG) vent process for venting boil-off gas generated in the storage tank and a vapor return process for returning hydrogen vapor to the storage tank to maintain hydrogen vapor pressure in the storage tank.

4. The device of claim 3,
wherein the simulation model for the liquid hydrogen storage system is configured to model the storage tank based on a horizontal storage tank of which a side surface of a cylinder faces the ground and upper and lower surfaces of the cylinder are perpendicular to the ground based on a top fill method in which liquid hydrogen is filled from the trailer tank to an upper end part of the storage tank.

5. The device of claim 2,
wherein the normal scenario data according to the steady-state model represents a scenario in which the liquid hydrogen supplied from the trailer tank is discharged to the cryo-pump after being filled up to the maximum capacity in the storage tank, and
the dynamic state model is configured to model a first fault scenario that occurs in a process in which the liquid hydrogen is filled from the trailer tank to the storage tank, a second fault scenario that occurs in a process in which the liquid hydrogen is delivered from the storage tank to the cryo-pump, and a third fault scenario that occurs in a process in which the liquid hydrogen delivered through the cryo-pump is vaporized in a heat exchange vaporizer.

6. The device of claim 5,
wherein the first fault scenario includes a scenario in which a vent threshold of a BOG vent process for venting boil-off gas (BOG) generated within the storage tank decreases, a scenario in which an external fire occurs, and a scenario in which a top fill method is changed to a bottom fill method,
the second fault scenario includes a scenario in which a return line valve is closed in a vapor return process for returning hydrogen vapor to the storage tank, a scenario in which a flow rate of liquid hydrogen delivered from the storage tank to the cryo-pump decreases due to impurity blockage, a scenario in which a flow rate of the liquid hydrogen delivered from the storage tank to the cryo-pump increases, and a scenario in which a residual amount of the liquid hydrogen within the storage tank is insufficient, and
the third fault scenario includes a scenario in which pressure at which the liquid hydrogen enters the heat exchange vaporizer from the cryo-pump increases.

7. The device of claim 1,
wherein the process variables used to obtain the normal scenario data and the fault scenario data includes hydrogen vapor pressure, hydrogen vapor temperature, and liquid hydrogen temperature measured in a storage tank of the liquid hydrogen storage system, and
the processor is configured to apply a cumulative sum (CUSUM) control method to the deviation data regarding the hydrogen vapor pressure, the hydrogen vapor temperature, and the liquid hydrogen temperature to calculate an upper end cumulative sum index Cᵢ⁺ and a lower end cumulative sum index Cᵢ⁻.

8. A model-based fault detection method for a liquid hydrogen refueling system using a cumulative sum method, which is performed by a processor executing instructions stored in a memory, the method comprising:
obtaining process variables inside a liquid hydrogen storage system based on a simulation model for the liquid hydrogen storage system;
obtaining normal scenario data and fault scenario data of the process variables by using a steady-state model and a dynamic state model for the liquid hydrogen storage system;
calculating an upper end cumulative sum index Cᵢ⁺ and a lower end cumulative sum index Cᵢ⁻ by applying a cumulative sum (CUSUM) control method to deviation data corresponding to a difference between the normal scenario data and the fault scenario data; and
detecting whether the liquid hydrogen storage system is faulty by comparing the upper end cumulative sum index Cᵢ⁺ and the lower end cumulative sum index Cᵢ⁻ with a threshold.

9. The method of claim 8,
wherein the simulation model for the liquid hydrogen storage system is configured to model mass balance and energy balance for a process of transferring liquid hydrogen from a trailer tank to a storage tank and a process of transferring liquid hydrogen from the storage tank to a cryo-pump.

10. The method of claim 9,
wherein the simulation model for the liquid hydrogen storage system is configured to further model mass balance and energy balance for a boil-off gas (BOG) vent process for venting boil-off gas generated in the storage tank and a vapor return process for returning hydrogen vapor to the storage tank to maintain hydrogen vapor pressure in the storage tank.

11. The method of claim 10,
wherein the simulation model for the liquid hydrogen storage system may be configured to model the storage tank based on a horizontal storage tank of which a side surface of a cylinder faces the ground and upper and lower surfaces of the cylinder are perpendicular to the ground based on a top fill method in which liquid hydrogen is filled from the trailer tank to an upper end part of the storage tank.

12. The method of claim 9,
wherein the normal scenario data according to the steady-state model represents a scenario in which the liquid hydrogen supplied from the trailer tank is discharged to the cryo-pump after filled up to the maximum capacity in the storage tank, and
the dynamic state model is configured to model a first fault scenario that occurs in a process in which the liquid hydrogen is filled from the trailer tank to the storage tank, a second fault scenario that occurs in a process in which the liquid hydrogen is delivered from the storage tank to the cryo-pump, and a third fault scenario that occurs in a process in which the liquid hydrogen delivered through the cryo-pump is vaporized in a heat exchange vaporizer.

13. The method of claim 12,
wherein the first fault scenario includes a scenario in which a vent threshold of a BOG vent process for venting boil-off gas (BOG) generated within the storage tank decreases, a scenario in which an external fire occurs, and a scenario in which a top fill method is changed to a bottom fill method,
the second fault scenario includes a scenario in which a return line valve is closed in a vapor return process for returning hydrogen vapor to the storage tank, a scenario in which a flow rate of liquid hydrogen delivered from the storage tank to the cryo-pump decreases due to impurity blockage, a scenario in which a flow rate of the liquid hydrogen delivered from the storage tank to the cryo-pump increases, and a scenario in which a residual amount of the liquid hydrogen within the storage tank is insufficient, and
the third fault scenario includes a scenario in which pressure at which the liquid hydrogen enters the heat exchange vaporizer from the cryo-pump increases.

14. The method of claim 8,
wherein the process variables used to obtain the normal scenario data and the fault scenario data includes hydrogen vapor pressure, hydrogen vapor temperature, and liquid hydrogen temperature measured in a storage tank of the liquid hydrogen storage system, and
the calculating includes calculating an upper end cumulative sum index Cᵢ⁺ and a lower end cumulative sum index Cᵢ⁻ by applying a cumulative sum (CUSUM) control method to the deviation data regarding the hydrogen vapor pressure, the hydrogen vapor temperature, and the liquid hydrogen temperature.

15. A computer program that is recorded on a non-transitory computer-readable storage medium,
wherein instructions of the computer program, when executed by at least one processor, cause at least one processor to perform a model-based fault detection method for a liquid hydrogen refueling system using a cumulative sum method.
